(19) United States
(12) Patent Application Publication
(10) Pub. No.: US 2013/0276065 A1
(43) Pub. Date: Oct. 17, 2013

(54) SYSTEM AND METHODS FOR RECEIVING AND CORRECTING CONTENT TRANSMITTED OVER MULTICAST CHANNELS

(71) Applicants: Derek D. Kumar, San Jose, CA (US); Hui Huo, San Jose, CA (US); Tamilselvakumar Vengan, Cupertino, CA (US); Nagendra Siravara, Cupertino, CA (US)

(72) Inventors: Derek D. Kumar, San Jose, CA (US); Hui Huo, San Jose, CA (US); Tamilselvakumar Vengan, Cupertino, CA (US); Nagendra Siravara, Cupertino, CA (US)

(21) Appl. No.: 13/916,009

(22) Filed: Jun. 12, 2013

Related U.S. Application Data
(63) Continuation of application No. 12/728,108, filed on Mar. 19, 2010.

(51) Int. Cl. H04L 29/06

(52) U.S. Cl. CPC H04L 63/062
USPC 726/3

(57) ABSTRACT

In one embodiment of the invention, a system and method for receiving and correcting content is provided. A receiver receives a plurality of transmission with embedded content key identifiers. Data packets for which the receiver has a corresponding authentication key are authenticated. Non-successful authentications, or data packets without a corresponding authentication key, are ignored by the receiver. The receiver checks if the content is encrypted. If so, the content may also be decrypted using content decryption keys stored within the receiver. Authentication keys and decryption keys may be updated via secure transmissions. The receiver status is monitored for incomplete and/or corrupted content receipt. The failed content may be retransmitted to the receiver over radio transmitters. Failed content may also be supplied to the receiver via the backchannel. Retransmission of the content may be performed according to a content delivery schedule.

### CLAIM OF PRIORITY

This non-provisional application is a continuation application of U.S. patent application Ser. No. 12/728,108, filed Mar. 19, 2010.

### CROSS REFERENCE TO RELATED APPLICATIONS

This application is related to co-pending and concurrently filed application Ser. No. 12/728,094, (Attorney Docket Number VUC-0901) filed Mar. 19, 2010, entitled “System and Methods for Delivering Content Efficiently Over Multicast Channels”, by Derek D. Kumar, Hui Huo, Tamilselvakumar Vengan and Nagendra Siravara, which is incorporated by reference herein for all purposes.

### BACKGROUND OF THE INVENTION

The present invention relates to content receipt and correction systems and methods. More particularly, the present invention relates to systems and methods for efficiently receiving and correcting content received over multicast channels, such as Radio Frequency (RF) spectrum. In some embodiments, this content receiving and correcting system may receive content on a one-to-many (multicast) platform whereby a central broadcaster transmits data to a plurality of receiver devices. Content may be routed to particular receiver devices using an embedded authentication key identifier. An authentication tag is included in a separate field in the content packet. The receiver devices include preloaded authentication keys. The authentication key identifier indicates which authentication key loaded within the receiver to utilize for the authentication protocol. The authentication result is then compared to the authentication tag. Matching authentication tags means that the content is genuine and uncorrupted; whereas a mismatching of the authentication tag and the authentication result indicates that the content is corrupted or fraudulent. Content that can be successfully authenticated is destined for the particular receiver. In an unrelated process, it may be desirable to encrypt the transmission such that the intended receiver devices are capable of accessing the content data. In these embodiments, predefined content encryption keys are used to ensure security of the content.

As is well known by those skilled in the art, modern digital data communication networks require the delivery of frames or packets of data (datagrams) from a source endpoint to one or more destination endpoints. A unicast transfer is the delivery of datagrams between one source endpoint and one destination endpoint. A multicast transfer is the delivery of datagrams between one source endpoint and a plurality (but subset) of possible destination endpoints. The method of transfer depends upon the underlying physical medium used to accomplish data transfer. Physical media used to deliver datagrams include, but are not limited to, short-range unlicensed wireless, long-range unlicensed and licensed wireless, satellite, optical fiber, cable, hybrid fiber/cable and direct point-to-point wiring, among others. Certain media are, by their inherent nature, more suited towards unicast or multicast transfers. In a wireless environment, many endpoints may be within the same radio-frequency (RF) signal coverage, especially in the case of centralized, high-powered transmissions such as radio, satellite, and television.

Currently, a number of known protocols and systems of digital data transmission are available. One such system includes the use of internet protocol (IP) format for datagrams. In an IP datagram, there are fields for the logical address (IP address) of the datagram source endpoint and the datagram destination endpoint. The IP address uniquely identifies the destination endpoint among all possible IP endpoints. An IP datagram is inherently a unicast transfer because it specifies its datagram destination endpoint. In order to accomplish unconstrained multicasting, separate datagrams are usually required.

When data communications bandwidth is unconstrained and the number of destination endpoints is small, the inefficiency of retransmission in an internet protocol method may be manageable. However, when implemented in data communication networks where the bandwidth is constrained and/or when the number of destination endpoints is very large, the network can quickly become saturated. To overcome this limitation, the IP format permits a restricted form of multicast addressing by applying a bit field mask (logical AND operation) to the IP address; however, this method depends on physical relationships among IP addresses. The IP format also supports limited multicasting through special IP addresses reserved to indicate data broadcasting. However, data broadcasting of this type is non-selective and its use can lead to limitless packet forwarding, which may cause significant network performance degradation. As a result, IP broadcasting is frequently disabled except in small networks.

On the other hand, non-IP multicasting is often used in mass media applications (broadcast radio/television, satellite radio and TV) to deliver predefined ‘channels’ of content to multiple endpoints. A limitation of this method is that the number of channels is constrained (by available transmission frequency) and aggregate network bandwidth is allocated according to the channels. Channel-based broadcasting may be effective when the data content may be categorized into a reasonable number of groups with minimal content overlap between groups. However, channel broadcasting is ineffective when the endpoints require datagrams from many different categorizations. Using a satellite TV analogy, channel-based broadcasting is efficient when viewers watch common programming on a single channel at a time. However, channel broadcasting is inefficient when the end-users wish to watch programs at different times across many different program categories. Furthermore, current broadcast methods are incompatible with the introduction of intermediary devices such as routers to limit data traffic propagation, which are required to deliver datagrams over disparate physical networks.

Despite these inherent limitations to current content delivery systems, there is a present and growing demand from end users (consumers) for personalized data delivery. This demand manifests itself in the rapid rise of internet usage over broadcast media for news, music and other data. However, given the relative low cost of broadcast media, wide coverage and established infrastructure, it is desirable to be able to provide on-demand delivery of a limitless range of data content utilizing broadcast media.

In view of the foregoing, systems and methods for receiving and correcting content over multicast channels, such as radio frequency spectrum, are disclosed. The present invention provides a novel system for providing any desired content (including video, text, audio, graphical information, etc.) to a wide variety of devices equipped with content receivers over Radio Frequency (RF) spectrum such as television spectrum, and Frequency Modulated (FM) radio. Authentication tags, determined by an authentication key, determine routing of the content to the proper endpoint device. Further, when security of the transmission is important, the system may be enabled to encrypt the content, whereby the delivery of specific data to particular receivers is achieved without sharing the data with other unauthorized receivers.

### SUMMARY OF THE INVENTION

The present invention discloses an efficient and secure content receiving and correcting system in which each user can select a personalized collection of content to receive at a personalized selection of end devices. Further, the user may select a personalized schedule in which to receive the content. More particularly, embodiments of the present invention include systems and methods for receiving and correcting content over multicast channels, such as radio frequency spectrum, in a manner that can achieve unicast, multicast and broadcast capability simultaneously. The secure content receiving and correcting system, in some embodiments, may be utilized to augment traditional transmission-based broadcasting infrastructure to provide specific data to specific receivers at designated times.

In one embodiment of the invention, a system and method for receiving content using a receiver unit is provided. The receiver may receive a plurality of transmissions from a transmission tower. In some cases the content may be encrypted. The transmitted content includes embedded authentication key identifiers. The receiver unit may parse through the authentication key identifiers for matches to an internal key registry stored in the receiver. When a match is made, the receiver may then authenticate the transmitted data packet. Packets which do not successfully authenticate, or which do not have a matching key identifier, may be ignored by the receiver.

In some embodiments, authentication using the key stored within the receiver produces an authentication result. This result is compared with an authentication tag also embedded within the data packet. After a successful authentication, the receiver may determine if the content is also encrypted. If so, the receiver may decrypt the content utilizing one or more decryption keys stored within the receiver.

The decryption keys within the receiver may be preloaded (user decryption key) or updated (content decryption key). The content decryption keys may be transmitted to the receiver in order to update the key registry within the receiver. This key update itself is encrypted utilizing a user decryption key, or an existing content decryption key already stored within the receiver.

After receipt of the content, the receiver, in some embodiments, may be configured to generate a status message. This status message may include identification of which content was received. The status message may then be provided to a content manager via a backchannel Likewise, in some embodiments, the receiver may identify errors with the content, including corrupted and missing content. These error messages may likewise be provided to the content manager via the backchannel.

In yet another embodiment, a system and method is provided for correction of data packets (packetized content) delivered using a one way data broadcast system. This system and method includes the transmission of an encoded data packet using a radio transmission to one or more target receivers. The data packet includes an embedded authentication key identifier that enables each target receiver to efficiently identify the data packets within the broadcast that are intended for it. The data packet's content, as noted above, may be transmitted in the clear, or may be encrypted. The targeted receivers are also able to generate response information and return a message to the system via a backchannel. In one embodiment, the backchannel is comprised of a cellular network or a wired medium. In some embodiments, the backchannel is used to send various data depending upon the deployment, such as missing packet information, system health information and proof-of-play information.

The system, in some embodiments, then receives the return message via the backchannel. The return information may include confirmation from a target receiver of delivery of the data packets, or a failure notification if some or all of the data packets that comprise a particular piece of content failed to be received or (when encrypted) decrypted successfully. The backchannel may use a different transmission mechanism than the radio transmission channel, so that a failure notification does not also fail to return to the system. The system tracks the confirmation of delivery and/or failure notifications to identify delivery losses. Then the system may generate timely data updates using the tracked confirmation of delivery. The data updates include repairs for the loss of data in delivery, and retransmissions for incomplete data packets. The data updates are then transmitted to the receivers. This transmission may be scheduled according to a desired delivery time for the data, which may be determined from a user profile. In some embodiments, the failed data packets need be retransmitted to the receivers, thereby reducing the bandwidth requirements for repairs to the content. Further, in some embodiments, the data packet repairs may be additionally transmitted via the backchannel to ensure complete delivery. Thus, for example, with a cellular return channel, the repair packets may be sent directly through the cellular channel, via the FM Subsidiary Communications Authorization (SCA) or through both channels.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a structural block diagram of an example of a secure content delivery system in accordance with an embodiment of the present invention;

FIG. 2 is a detailed structural block diagram of the multimedia delivery system providing content to a variety of receiver devices in accordance with an embodiment of the present invention;

FIG. 3 is a structural block diagram for a user interface of the multimedia delivery system in accordance with an embodiment of the present invention;

FIG. 4 is a structural block diagram for a content manager of the multimedia delivery system in accordance with an embodiment of the present invention;

FIG. 5 is an example illustration of a relay system for the delivery of content in accordance with an embodiment of the present invention;

FIGS. 6A to 6G provide example flow diagrams for the process of delivering and repairing content to receivers, using the content delivery system, in accordance with an embodiment of the present invention;

FIG. 7 is an example flow diagram for the process of receiving the transmitted content, using a receiver device, in accordance with an embodiment of the present invention;

FIG. 8 is an example flow diagram for the process of generating a user profile, using the content delivery system, in accordance with an embodiment of the present invention;

FIG. 9 is an example flow diagram for the process of relaying broadcast content to an inaccessible endpoint location, using receivers and ISM relays, in accordance with an embodiment of the present invention;

FIGS. 10-13 provide example illustrations of datagram protocol formats in accordance with some embodiments of the present invention;

FIG. 14 is an example process flow for the delivery of datagrams associated with a single context, using the content delivery system, in accordance with some embodiments of the present invention;

FIG. 15 is an example process flow for the delivery of datagrams associated with a pair of contexts, using the content delivery system, in accordance with some embodiments of the present invention;

FIG. 16 is an example block diagram of the coding of data messages with differing Service Key Identifiers (SKIs) for the delivery to particular endpoints in accordance with some embodiments of the present invention; and

FIG. 17 is an example block diagram of the coding of data messages with differing SKIs through a SKI router for the delivery to particular endpoints in accordance with some embodiments of the present invention.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Certain embodiments of the present invention relate generally to systems and methods for receiving and correcting content transmitted over multicast channels. In some embodiments, the multicast channels may include underutilized Radio Frequency (RF) spectrum. In some embodiments, this content receipt and correction system is capable of effectively receiving content that is transmitted on a one-to-one (unicast), one-to-many (multicast), and one-to-all (broadcast) basis, while a central broadcaster transmits data to a plurality of receiver devices. In some embodiments, the content may be encrypted utilizing predefined content encryption keys to ensure particular content is only viewable by a particular receiver (which includes the corresponding content decryption key). In other embodiments, the content may be transmitted in the clear. Content transmissions, regardless of encryption status, include one or more authentication key identifiers for authentication purposes and therefore proper routing of the content. For the sake of this application, the term “broadcast” may be defined as sending information from a source to all destinations simultaneously. In some embodiments, the system takes advantage of the distributed nature of the internet and broadcast capability of FM/TV transmission to create an efficient unicast and/or multicast network for data delivery.

Note that, in the remainder of this application, particular attention will be placed upon transmission through radio towers. Further, attention is placed upon coding content for transmission on Frequency Modulated (FM) radio subcarrier signals (i.e., SCA). It is intended, however, that the present invention be adapted for use with any broadcast media type, regardless of origin or spectrum. Thus, satellite transmission, television, AM frequencies, in band on-channel (IBOC) broadcasting in the AM and FM bands, and other broadcast signals may be also suited for use in conjunction with the present content delivery system.

The following description of some embodiments of the present invention will be provided in relation to numerous subsections. The use of subsections, with headings, is intended to provide greater clarity and structure to the present invention. In no way are the subsections intended to limit or constrain the disclosure contained therein. Thus, disclosures in any one section may apply to other sections, as is applicable.

### I. SECURE CONTENT DELIVERY SYSTEM

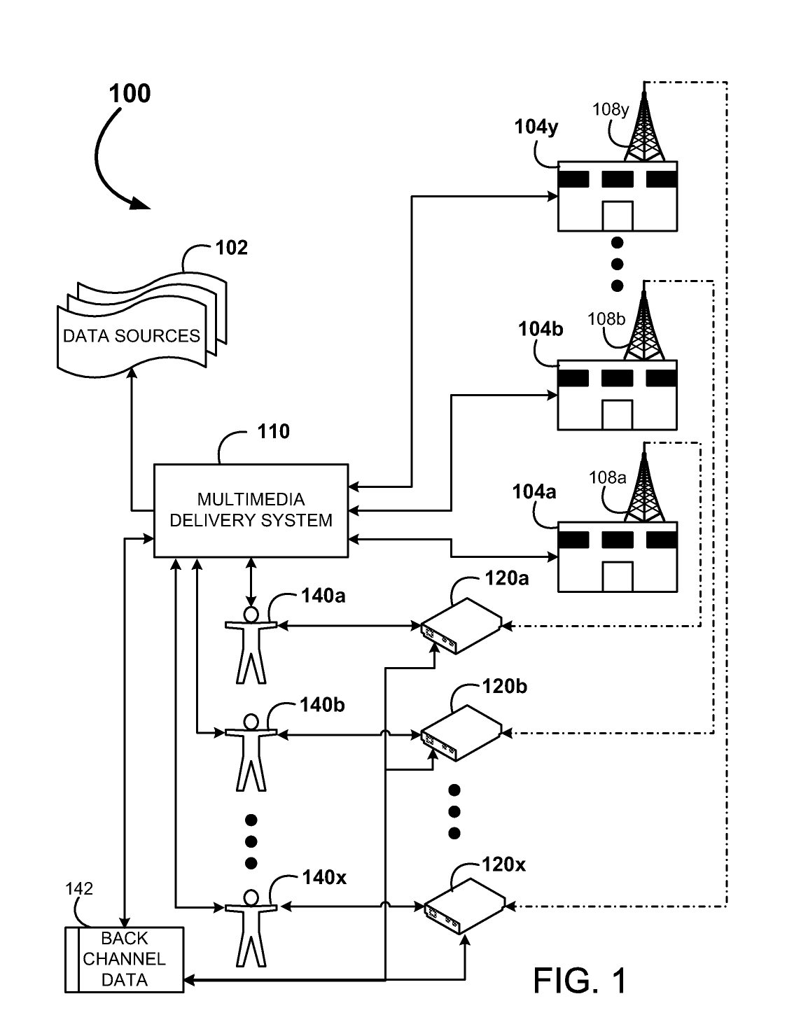

FIG. 1 is a structural block diagram of an example of a Content delivery system 100 in accordance with an embodiment of the present invention. A Multimedia Delivery System 110 may access Data Sources 102 in order to compile the content for multicasting. The Data Sources 102 may include any public data source (i.e., free-to-distribute content) as well as possible private databases (such as individual or corporate datasets, and/or data uploaded by the user). The Multimedia Delivery System 110 may determine which content is to be delivered, as well as delivery time requirements, through accessing of user profiles. The Users 140a to 140x may directly access the Multimedia Delivery System 110 in order to set up and personalize these profiles. The user profiles may be generated and accessed through a web-based application, web-service or mobile applications, in some embodiments.

In some embodiments, the Multimedia Delivery System 110 may provide the content to be transmitted to any of a plurality of Stations 104a to 104y. The Stations 104a to 104y may, in some embodiments, generate a Subsidiary Communications Authority (FM SCA) transmission signal for transmission via the Transmitters 108a to 108y. Additionally, other known methods of data multiplexing may likewise be utilized for the transmission of content datagrams. The transmitted data may then be received and decoded by each of the Receivers 120a to 120x. Each of the Transmitters 108a to 108y may include a particular known geographic coverage. Therefore, the data determined to be sent to a particular Receiver 120a may be routed by the Multimedia Delivery System 110 to one or more of the particular Stations 104a to 104y such that the data is broadcast to an area capable of being received by the targeted Receivers 120a to 120x.

In some embodiments, one or more of the Receivers 120a to 120x may be associated with a given User 140a to 140x. In some cases, any particular User 140a to 140x may have multiple Receivers 120a to 120x. For example, where the particular User 140a is a corporation, it may be desirable for each of its managers to have access to a Receiver 120a. Moreover, given the range of devices a Receiver 120a may be integrated into, a single individual may wish to have a variety of Receivers 120a to 120x for personal use.

As will be discussed in greater detail below, each Receiver 120a to 120x may include one or more authentication keys associated with the device, as well as one or more user decryption keys associated with the device. The identity of these authentication keys and/or user decryption keys may be known by the Multimedia Delivery System 110 through reference to an internal key registry and/or access to the user (subscriber) profile. The Multimedia Delivery System 110 may encrypt content intended for a particular receiver with a content encryption key corresponding to one of the content decryption keys included in that receiver. Other times content may remain unencrypted when security of the transmission is not at issue. For example, emergency notifications may be transmitted in the clear as there is little need for security. In fact, it may be advantageous for emergency notifications to be as widely distributed as possible. The system may further embed an authentication key identifier with the content indicating which receivers the content is intended for. Likewise, an authentication tag is included in a separate field in the content packet. The authentication key identifier indicates which authentication key loaded within the receiver to utilize for the authentication protocol. The authentication result is then compared to the authentication tag to determine authenticity of the data. Thus, the authentication key identifier paired with the authentication tag may facilitate routing of the datagrams. Thus, the Receivers 120a to 120x may monitor the authentication key identifiers embedded with the broadcasts to efficiently select from the broadcast stream the data packets which they have a authentication key for. Further, the content decryption keys may be utilized by the Receivers 120a to 120x to decrypt particular received encrypted content which is intended for the particular Receiver 120a, when applicable. Thus, a wide range of data may be broadcast over a particular geographical area, yet the intended recipients of particular content authenticate the datagrams. Further, when desired, content may be transmitted securely (encrypted) and only the intended receivers are allowed access to that content.

Note that in some embodiments, each receiver may initially include a user decryption key or keys. Thereafter, additional content decryption keys may be sent to the receiver and/or content decryption keys may be updated at any later given point, via an encrypted transmission that includes a new or updated content decryption key. This transmission may be encrypted using the initial user encryption key which is the counterpart to the user decryption key which was preloaded within the receiver. In some embodiments, each user decryption key may be unique to that given receiver. Likewise, the authentication keys stored within a given receiver may be updated in a similar manner. Further, instructions for the proper management of key may be received. These instructions may direct the receiver to delete unused or cancelled authentication keys and/or decryption keys.

Occasionally, as with any broadcast system, there may be data corruption or loss. To address this issue, the Receivers 120a to 120x may compile data regarding device status and content received. This information may be provided over a backchannel as Backchannel Data 142 to the Multimedia Delivery System 110. The backchannel, in some embodiments, uses a different media than the transmitted data. For example, a modem, or cellular network may be readily adapted for use as the backchannel. As the volume of Backchannel Data 142 is relatively small, there is very little burden placed upon the backchannel networks.

The Backchannel Data 142 may be analyzed by the Multimedia Delivery System 110 to determine which data packets have been received and which been lost or corrupted. Thus, the Multimedia Delivery System 110 may utilize this Backchannel Data 142 to determine retransmission of particular content to the Receivers 120a to 120x. Retransmission may occur via the FM SCA, and/or may include transmission over the backchannel medium as well, to ensure proper delivery. In some embodiments, the receivers may send periodic status messages regarding content received to the Multimedia Delivery System 110. The Multimedia Delivery System 110 may then perform the analysis on the backchannel data when the status messages are received.

In yet other embodiments, the receivers may be configured to be able to monitor completeness of transmissions, and may be able to identify transmission failures and losses, including the failure of particular data packets to arrive or decrypt. In these embodiments, the receivers may communicate with the Multimedia Delivery System 110 via the backchannel when a transmission failure occurs.

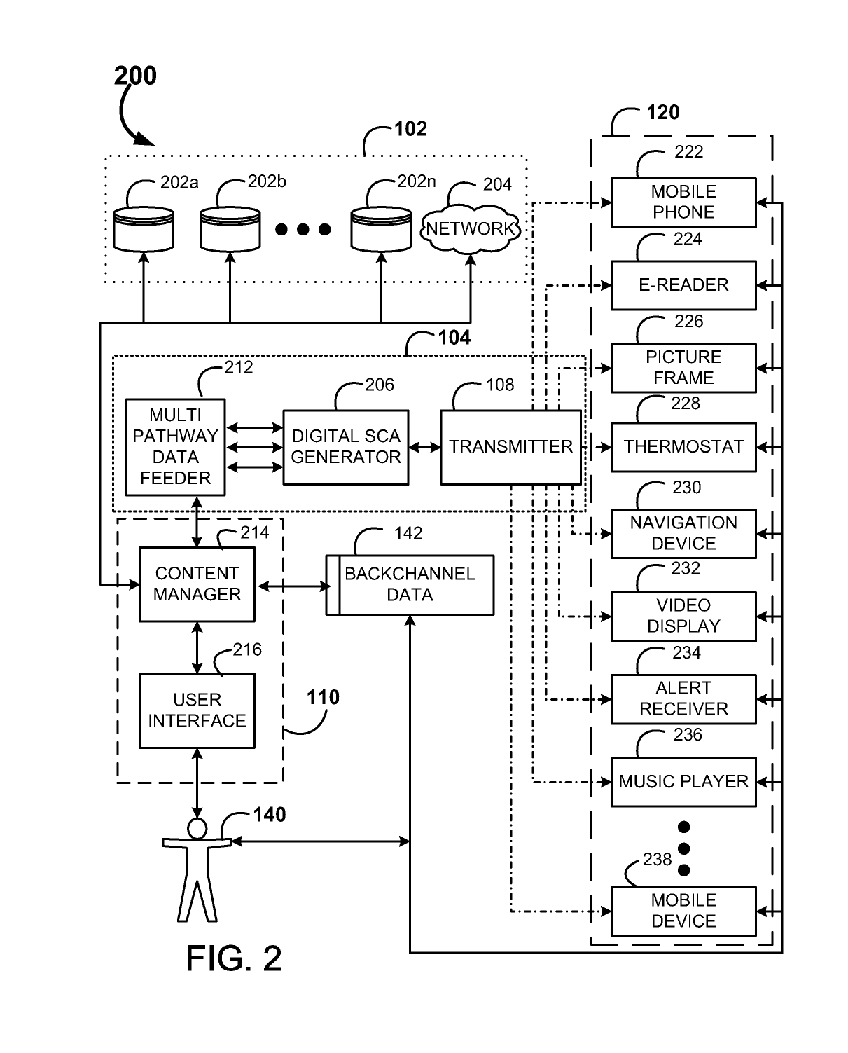

FIG. 2 is a detailed structural block diagram of the Multimedia Delivery System 110 providing content to a variety of Receivers 120a to 120x in accordance with an embodiment of the present invention. Here particular components of the Content delivery system 100 may be seen illustrated in greater detail as to enable a greater understanding of a particular embodiment of the present invention.

For example, a Receiver 120 may be seen as including a variety of devices, including, but not limited to Mobile Phone 222, E-Reader 224, Digital Picture Frame 226, Thermostat 228, Navigation Device 230, Video Display 232, Alert Receiver 234, Music Player 236 and any other applicable Mobile Device 238. The Multimedia Delivery System 110 may securely and efficiently provide useful data to each of these device types. For example, a Mobile Phone 222 equipped with a receiver may receive mobile formatted content. The user may have the ability to choose and personalize the content; the system may, in some embodiments, intelligently schedule and deliver the content in the right format to the targeted mobile device at the appropriate time Likewise, the E-Reader 224 may receive personalized content such as electronic books, electronic newspapers and electronic periodicals. A Digital Picture Frame 226 may receive digital photos, advertisements and videos.

A Thermostat 228 may receive information relating to demand response and load balancing, for energy management and saving, in some embodiments. For example, during peak load situations, utility companies could send digital data to targeted thermostats over FM channels. The Thermostat 228 may automatically adjust to run more efficiently in response to these instructions. Information such as system status, weather, pricing, emergency status, etc., may also be sent to thermostats equipped with receivers.

A targeted Navigation Device 230 may receive traffic information, road conditions, weather updates, driving maps, etc., in some embodiments. A Video Display 232 equipped with a receiver may receive and store the content in local storage and render the content. This could be used in commercial as well as non-commercial applications, in some embodiments, to disseminate multimedia content. An Alert Receiver 234 may receive emergency alerts or disaster management information. This information may be broadcast in localized areas or over a broad area depending on the need. Using the unicast and multicast capabilities of the system, the information may be targeted to the receivers in a localized areas affected by the emergency situation. The end devices could, in some embodiments, include handheld devices or devices installed in public places, or personal mobile devices equipped with the receivers. Other Mobile Devices 238 may include computer systems, automobiles, PDA's or similar device types.

As noted before, the User 140 may access the Receiver 120 (regardless of device type the Receiver 120 is integrated into) for consumption of the received content. Likewise, the Receiver 120 may generate the Backchannel Data 142 as noted before.

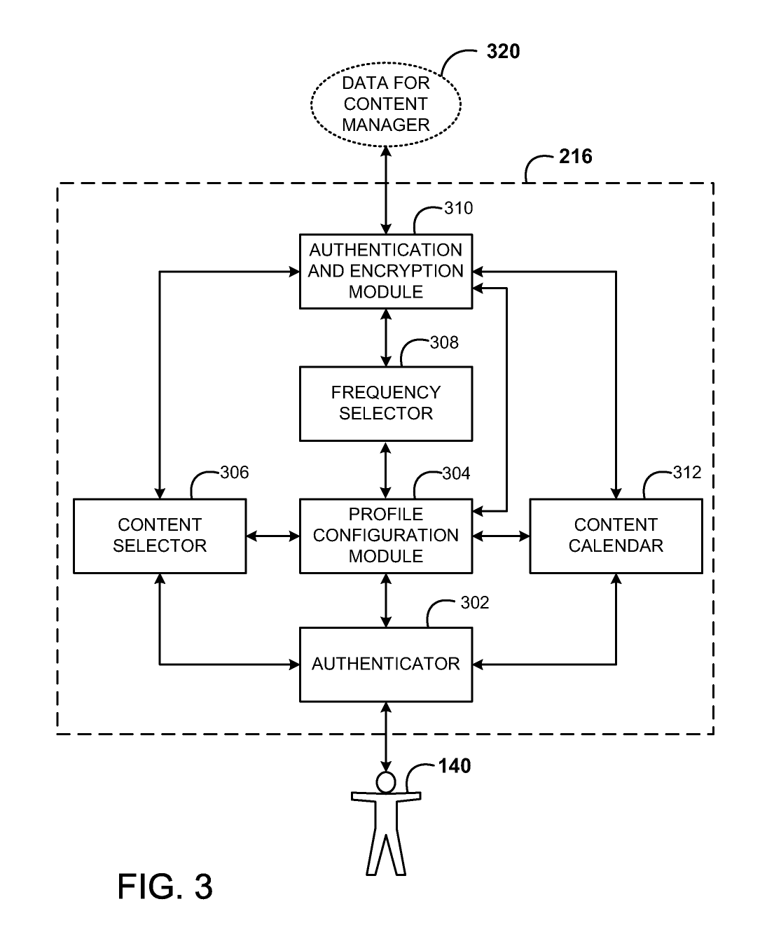

The User 140 may access the Multimedia Delivery System 110 via a User Interface 216. The User Interface 216 may, in some embodiments, include a web-based application, web-service or mobile applications for the personalization of the user profile. The User 140 may choose the content and sets preferences for the delivery of the content based on location, time, etc. The User Interface 216 may couple to a Content Manager 214 for generation of a content schedule. One embodiment of the User Interface 216 is explored in more detail below in conjunction with FIG. 3.

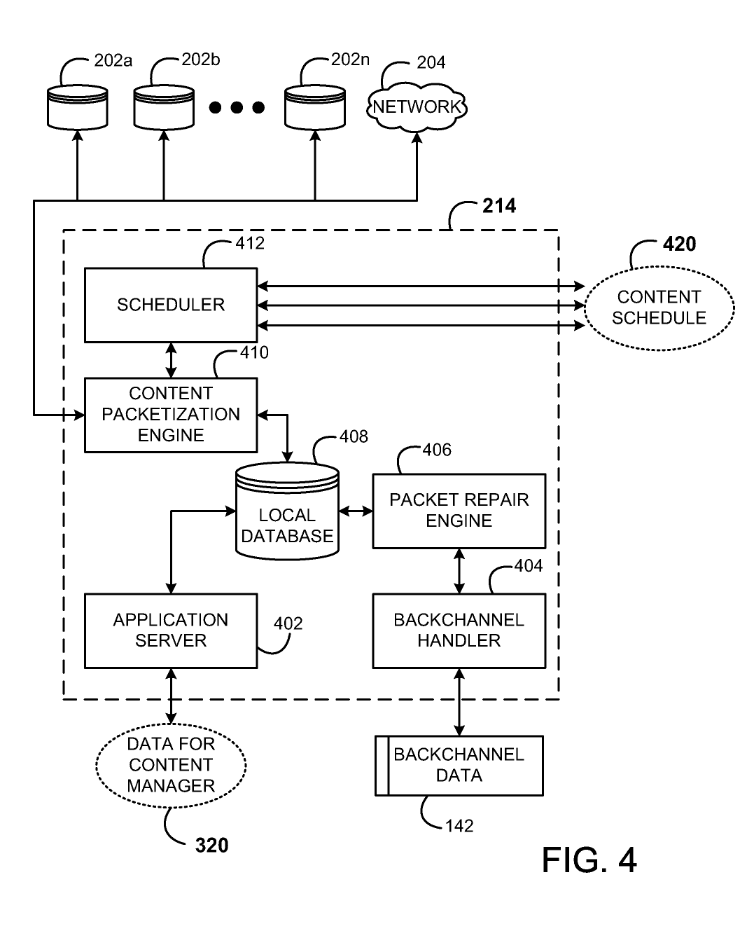

The Content Manager 214 may access the Data Sources 102 to manage content collection and delivery scheduling. The Content Manager 214 may, in some embodiments, intelligently schedule delivery of content to various targeted devices taking into account the bandwidth available for broadcast transmissions, time at which the content needs to be received by the receiver, and size of content to be broadcast. This allows for efficient use of the FM bandwidth in broadcasting data (content) to a large number of receivers, with different items of data content effectively being broadcast, multicast and unicast, all from the same transmission source. One embodiment of the Content Manager 214 is explored in more detail below in conjunction with FIG. 4.

The Data Sources 102 may include a plurality of sources labeled 220a to 220n. These sources include, but are not limited to, video databases, music databases, picture databases, personal databases, public databases, corporate databases, and virtually any other content the User 140 has authorized access to. Content may also be uploaded using the application user interface by the user or users. For some content, automated software tools may be used to upload content without further manual intervention, for example, uploading scheduled content which is regularly updated from a known location. Additionally, the Data Sources 102 may include any content accessible from the Internet 204. Thus, a virtually infinite amount of content may be available for delivery based upon user preferences and accessibility. In general, content data may be stored as files on traditional file systems or in other forms such as BLOBS (Binary Large Objects) or other storage mechanisms.

After collecting the required content and generating the content schedule, the Content Manager 214 may provide the content to a Multi-Pathway Data Feeder 212. The Data Feeder 212 parses the content file in packet format, reads the packets, adds an RTP header and sends the packets to the SCA generator subject to the constraints of the SCA generator (e.g., throughput limitations). In some embodiments, the Multi-Pathway Data Feeder 212 pumps content data to the Subcarrier Generator 206 on multiple pathways. These pathways may include logically and physically distinct data paths. Each pathway may carry different content types; for example, audio, video, images, etc. The Multi-Pathway Data Feeder 212 may be capable of identifying different content type and guiding them through multiple pathways. The content may be packetized and, when appropriate, encrypted for security. In some alternate embodiments, the content packetization and, when appropriate, encryption may be preformed by the Content Manager 214 prior to receipt by the Multi-Pathway Data Feeder 212. The Multi-Pathway Data Feeder 212 may also embed the content key identifiers in the data packets of the content to facilitate key based routing.

The Subcarrier Generator 206 may be configured to, in some embodiments, combine various input data sources and generate the FM subcarrier signal. The subcarrier signal, as will be discussed in greater detail below, may be injected into the SCA port on a standard FM transmitter 108 which connects to an FM tower. The Subcarrier Generator 206 may be configured to occupy specific bandwidth in the allocated FM spectrum. Every targeted Receiver 120 is, in some embodiments, coded with one or more content authentication keys before it may authenticate the content. Also, when applicable, the target receiver is coded with one or more decryption keys such that it is capable to decrypt the content. Authentication key identifiers may be embedded with the content (regardless of encryption status) for authentication purposes. The content to specific targeted devices may thus be routed based on the authentication key(s) resident on each receiver. Likewise, when content is encrypted, only a receiver with a specific content decryption key or keys may decode particular encrypted content.

FIG. 3 is a detailed structural block diagram for an embodiment of the User Interface 216. Along with the user management, the system may have other components such as key management, end device location management, encoder management, and various reporting tools, depending upon the application. In this figure, the User 140 is seen accessing the User Interface 216 via an Authenticator 302. The Authenticator 302 may utilize any authentication methodology known in the art in order to provide secure access to the proper User 140. Authentication may include the usage of passwords and usernames or other identification methods. This access may be across a web-based application, web-service or mobile applications, in some embodiments.

The User Interface 216 may include a Content Selector 306, a Profile Configuration Module 304 and a Content Calendar 312. Aspects of any of these modules may be configured to enable the User 140 to personalize or alter the data stored in them. For example, the Profile Configuration Module 304 may include information related to the User 140 including address, contact information, demographic information, billing information and receiver information. This receiver information may include which receivers are associated with the given User 140, categories/capabilities of the receivers, as well as the authentication keys associated with each receiver, and user decryption keys associated with each receiver. Below, at Table 1 is an example Key table:

TABLE 1
Key Table

| | |
|---|---|
| NAME | LOCATION_NAME |

RECEIVER_ID
ENCODER_NAME
FREQUENCY

In this example key table, RECEIVER_ID field uniquely identifies an end receiver, and is used to send service/content decryption key(s) to targeted receivers. The FREQUENCY field identifies the frequency to which the receiver is tuned to. The coverage area to which the receiver belongs to is identified by the ENCODER_NAME field which is linked to the ENCODER table shown below at Table 2.

TABLE 2
Encoder Table

| | | |
|---|---|---|
| NAME | LOCATION_NAME | IP ADDRESS |

| | |
|---|---|
| BANDWIDTH | ACCESS_PORT |

| | | |
|---|---|---|
| PORT_1 | PORT_2 | PORT_3 |

| | | | |
|---|---|---|---|
| PORT_4 | PORT_5 | PORT_6 | PORT_7 |

BITRATE

In some embodiments, the location information within the Profile Configuration Module 304 may be longitude and latitude coordinates, or may include GPS feeds to actual location. The use of GPS may be particularly useful when the receiver is mobile, such as a receiver in a vehicle, a Navigation Device 230, or a receiver associated with a Mobile Device 238.

The Content Selector 306 may be accessed by the User 140 to determine what content the User 140 may wish to receive on each of her receiver devices. This module, in some embodiments, may be logically divided by device type or content type. The User 140 may then select content from personal databases, public databases, subscribed to databases, and from the internet. Thus, for example, a user may schedule delivery of randomized songs from her music library to be delivered to her Music Player 236, the most recent copy of the New York Times®, of which she has a subscription, delivered to her E-Reader 224, and breaking news found on a public website to be sent to her Mobile Device 238.

At the Content Calendar 312, the User 140 may then be able to schedule the time she wishes to receive the content. In some embodiments the Content Calendar 312 can support both time-based scheduled or sequential scheduling. Time-base scheduling ensures that content is played at specific times while sequential scheduling guarantees the order in which content is played. Returning to our previous example, the User 140 may wish that the New York Times® be available during the week by 7:00 am and on Sunday by 9 am. Further, she may wish the songs be delivered to her Music Player 236 by 10:00 am, so that she can listen to music at work. Lastly, assume that she wishes any urgent news be directed to her Mobile Device 238 promptly after it becomes available. All of such deadlines for data delivery may be designated utilizing the Content Calendar 312.

In some embodiments, a Frequency Selector 308 may access the Profile Configuration Module 304 for device capabilities and location restrictions to determine the frequency of the subcarrier signals which provide the best coverage of the transmitted data to the Receivers 120a to 120x. Alternatively, in some embodiments, the frequency selection may occur at a later stage closer to transmission based upon level of use of the subcarrier frequencies.

An Authentication and Encryption Module 310 may determine which authentication key identifiers to embed within the content for proper routing to the intended receiver. This decision may be based upon the intended receiver the content is supposed to be received by. Thus, returning to the above example, the authentication key identifier selected to be embedded with the transmission of the music data may indicate that the authentication key found within the Music Player 236 may be utilized to authenticate the content. Likewise, the Authentication and Encryption Module 310 may, in some embodiments, determine whether the content is to be encrypted. If so, the Authentication and Encryption Module 310 may indicate which content encryption key(s) to utilize to encrypt the data when the content requires a secure transmission. Again returning to the music example, it may be required that the music data be encrypted due to copyright restrictions. Thus, the Authentication and Encryption Module 310 may utilize an encryption key corresponding to a decryption key found within the Music Player 236 in order to ensure the music player is the only device capable of accessing the transmitted data (as opposed to determining the authenticity of the transmitted data).

Lastly, in some embodiments, the content identification, content delivery deadlines, frequency selections authentication key identifiers and content encryption keys each content may be encrypted with (when encryption is desired) may be provided as Data 320 to the Content Manager 214. This may also be seen at FIG. 4, which provides an embodiment of a structural block diagram for the Content Manager 214.

The Data 320 for the Content Manager may be received by an Application Server 402. The Application Server 402 may also enable administration of the entire network and individual elements of the network. The Application Server 402 may store encoder location information and cross reference this with the receiver location information. Thus, the appropriate transmitter tower(s) for broadcasting the data may be identified for each set of data. This location data may be stored within a Local Database 408. The Local Database 408 may also be enabled to provide local information storage for the entire Content Manager 214.

A Data Packetization Engine 410 may packetize the collected content. One or more authentication key identifiers are embedded with the data packets to enable the receivers to rapidly determine which packets are intended for each receiver (i.e., for proper routing). Thus, the receivers may authenticate the data using the authentication key identifiers in order to verify that the data is genuine (i.e., sent from an authentic data source). The Data Packetization Engine 410 may also, in some embodiments, encrypt the data, when desired, at the point of packetizing using one or more encryption keys. Thus, only Receivers 120a to 120x which include the appropriate content decryption key(s) may access the secured data once it has been transmitted. These two features enable key-based routing of data, and ensures that data is only accessible by the appropriate recipient (when content is encrypted) even though it is being multicast.

The packetized data may then be provided to the Scheduler 412 for generation of a content schedule. The Scheduler 412 cross references the delivery deadline, content size and bandwidth availability to generate a scheduled time for content to be broadcasted. In addition, the Scheduler 412 may provide a time buffer to allow for packet re-transmission to correct for corrupted or incomplete transmissions, and to balance load on the system. The Scheduler 412 may, in some embodiments, utilize a simple optimization algorithm to allocate time slots to the transmission of the content encoded in data packets. The Content Schedule 420 may then be provided to the broadcasters for transmission.

In some embodiments, the Content Manager 214 may also receive the Backchannel Data 142 indicating what content was, or was not, received by the targeted Receivers 120a to 120x. A Back Channel Handler 404 may collect this Backchannel Data 142 and compare against what the Receivers 120a to 120x were supposed to have received to determine what content was corrupted or lost. Weather, interfering signals, weak signal strength, and device outages are all possible causes of data loss.

The Packet Repair Engine 406 may then determine which data packets are needed to be retransmitted in order to correct the errors in the original transmission. This process of feedback and retransmission to correct for incomplete data receipts may be repeated as many times as necessary, in some embodiments, in order to provide a robust system of delivery. In some alternate embodiments, errors may be tracked and unusually large levels of data loss may trigger the system to cease transmission and an error message to be generated. In yet other embodiments, this may elicit a repair request or a test protocol to determine if there is a hardware malfunction or other system correction required. Further, in some embodiments, repair data may additionally be provided via the backchannel to ensure robust transmission.

In some embodiments, errors to the transmission of content may be corrected by retransmitting those data packets that are damaged and/or lost. In these embodiments, the receiver may be enabled to recognize packet order and repair and/or replace the retransmitted packets. Thus, retransmission bandwidth requirements may be greatly decreased.

Additionally, in some embodiments, the receiver itself may be enabled to track the data packets received and notify the delivery system that a transmission error has occurred when data packets are not received, or are corrupted. These embodiments further decrease the burden placed upon the backchannel since receivers with transmission errors are communicating with the delivery system.

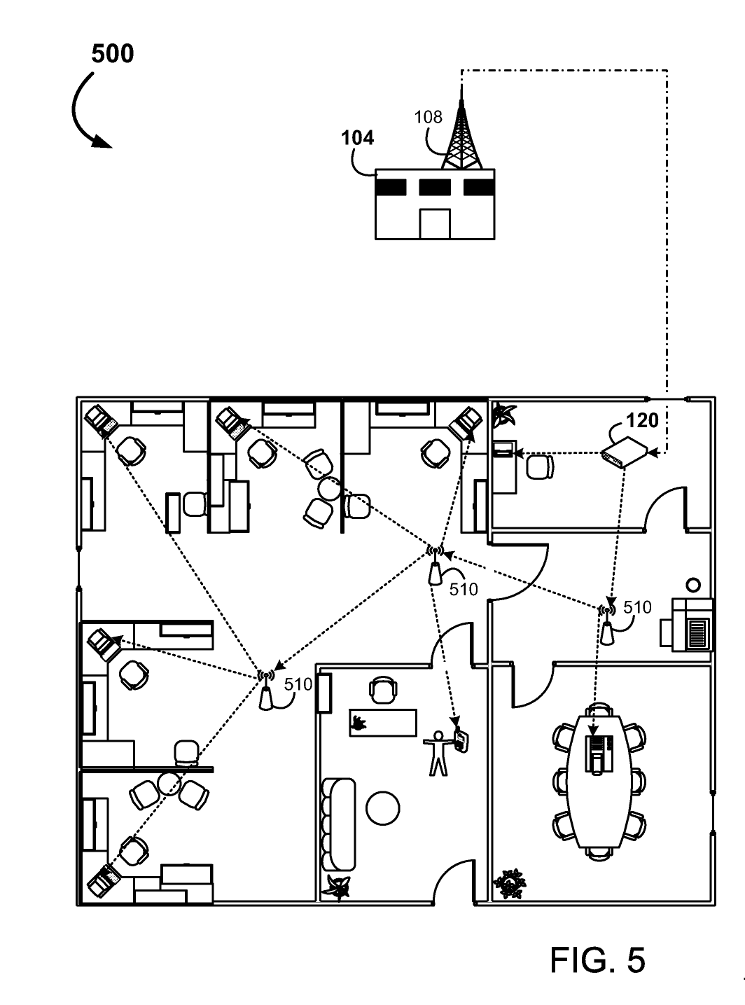

FIG. 5 is an example illustration of a relay system for the delivery of content in accordance with an embodiment of the present invention, shown generally at 500. Here a Station 104 may be seen with a Tower 108 transmitting a FM band subcarrier signal to a Receiver 120. The Receiver 120 may be situated in a location adapted to readily receive the transmission with little interference. However, it may be the case that the content data is not usable at this location, and retransmission of the content over Industrial, Scientific and Medical (ISM) band would be particularly helpful. This example layout may be particularly helpful in situations where FM/TV signals may not be strong enough inside multi-walled buildings and commercial structures to facilitate direct transmission. Note that although retransmission of the content is described in terms of ISM band frequencies, it is intended that any unlicensed bands suitable for localized low power transmission may be applicable.

In the illustrated embodiment, the Receiver 120 may include an ISM transmitter as well as an FM receiver. The Receiver 120 may likewise include a set of authentication keys such that data desired to be delivered to the particular building are retransmitted. In a corporate office, the Receiver 120 may include content decryption keys associated with each corporate device. In some alternate embodiments, all authenticated data received by the Receiver 120 may be retransmitted over the ISM bands regardless of encryption.

In addition to the Receiver 120, a series of Relays 510 may be deployed to receive the ISM transmission and retransmit the data for access by the end use devices. In this way, transmitted data may be enabled to penetrate deeply into office buildings where an FM or TV transmission would not be able to penetrate.

### II. METHODS FOR SECURE CONTENT DELIVERY

Below are provided a number of exemplary process flows for the delivery of data over a multicast radio transmission with key based routing. These examples are intended to provide an understanding of some embodiments of the process of data delivery utilizing at least one of the above system examples provided in the previous subsection. It is intended that any logical permutations, alterations and deletions to the foregoing process is included in the purview of the present invention if it were reasonably evident to one skilled in the present art.

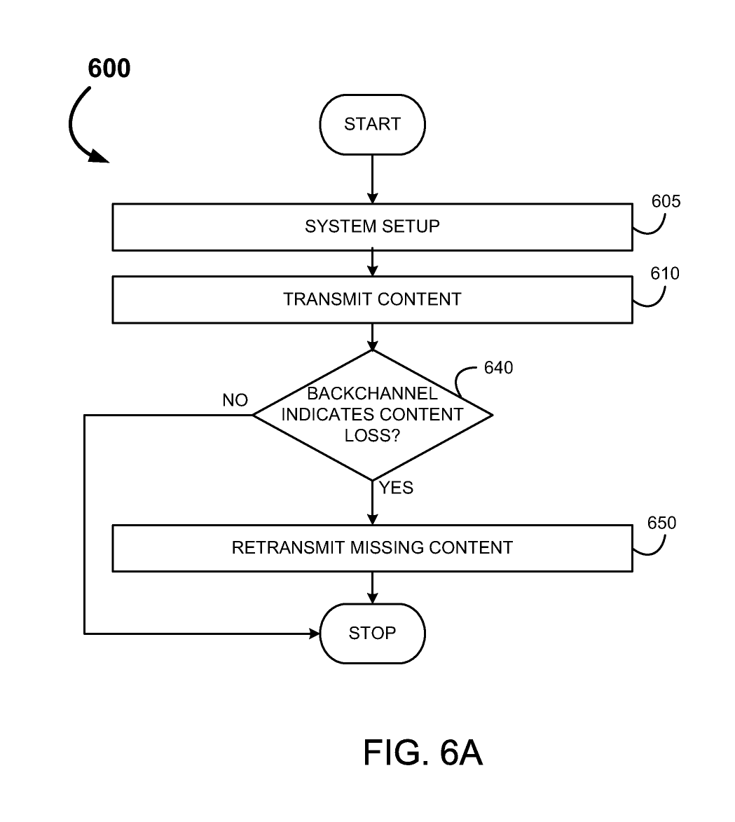

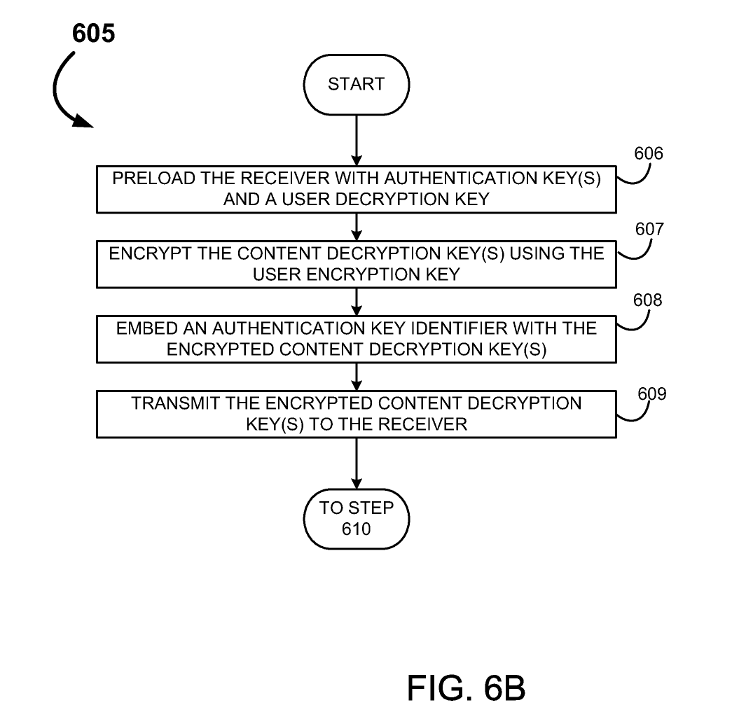

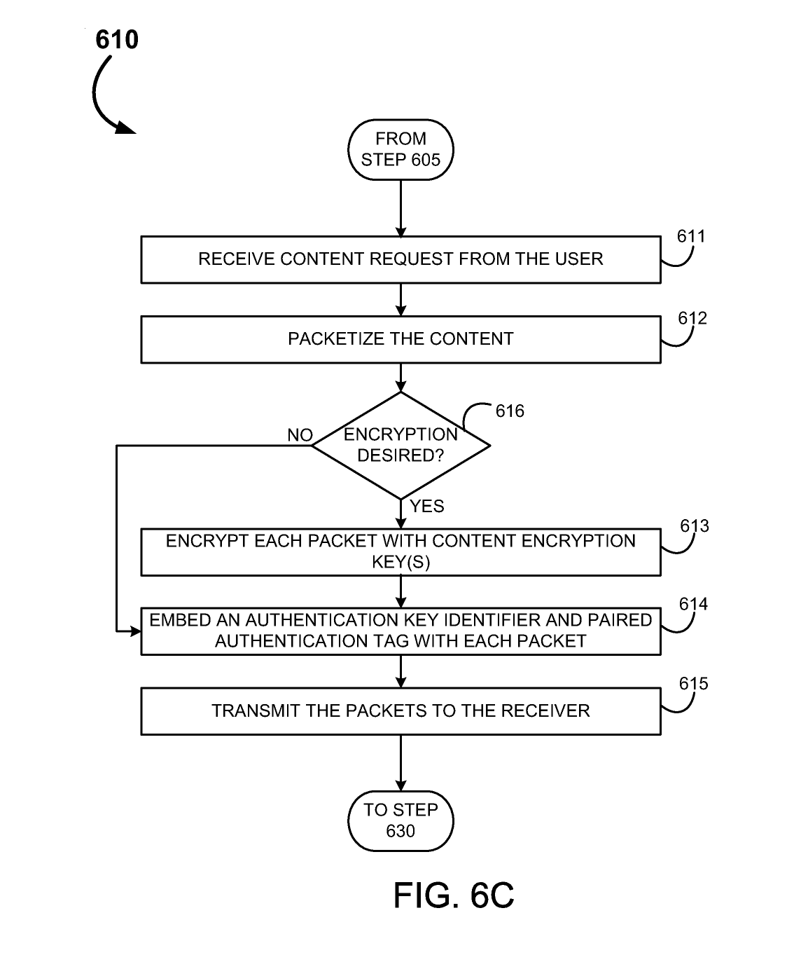

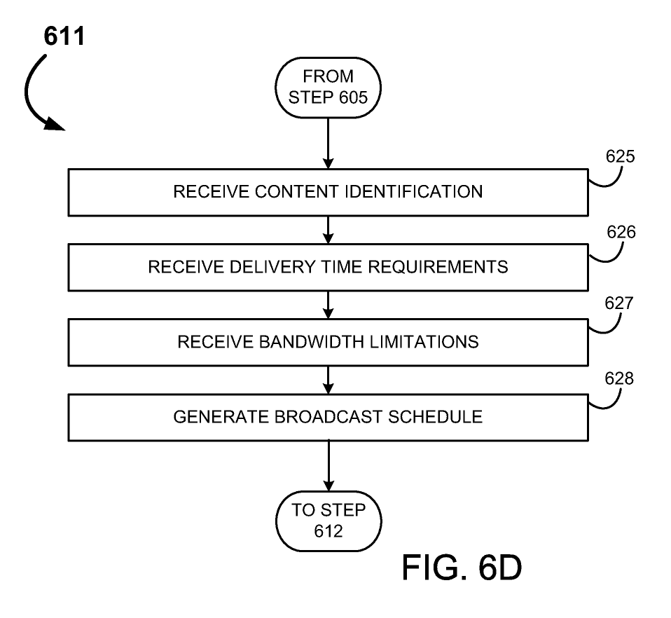

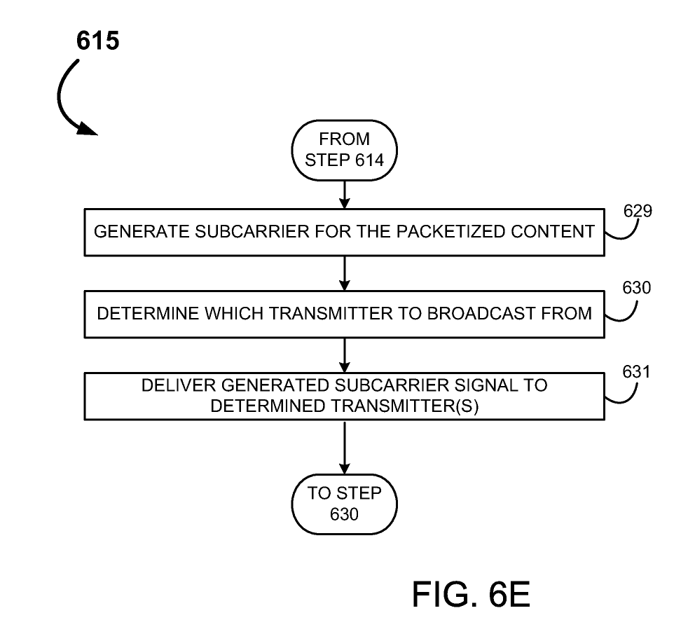

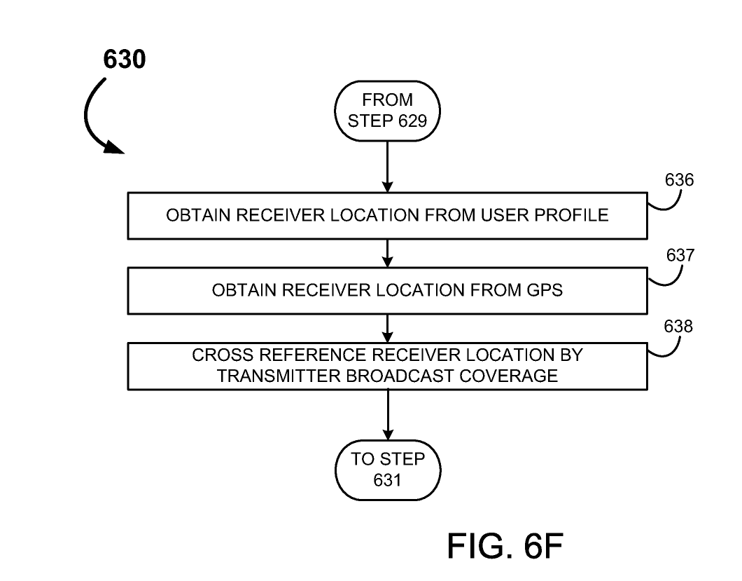

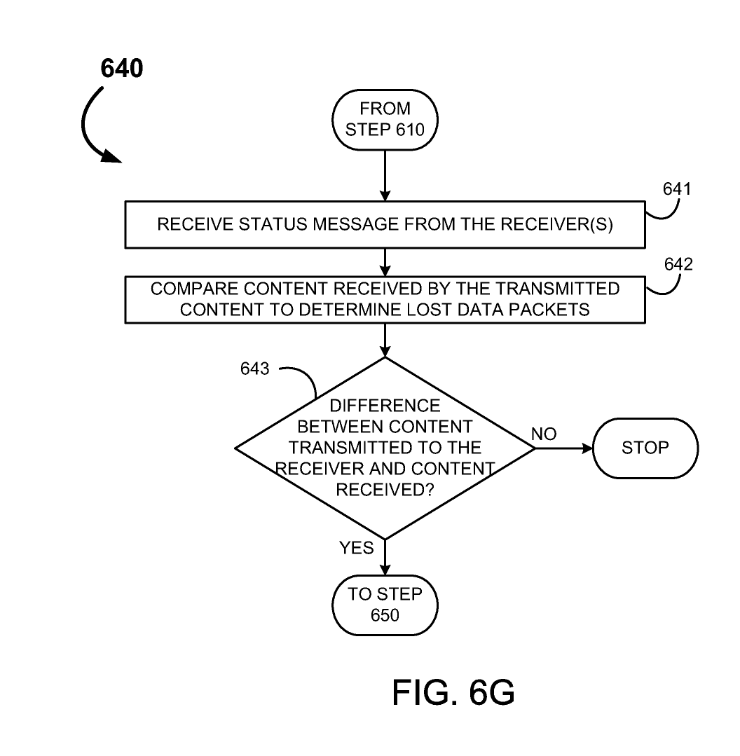

FIG. 6A is an example flow diagram for the process of securely delivering content, using the content delivery system, shown generally at 600. This process begins from step 605 where the system undergoes a setup. Then, at step 610, the content is transmitted to the receivers. An inquiry is then made, at step 640, as to whether a backchannel message has been received indicating an error in transmission. If a transmission error has occurred, then the process progresses to step 650 where the missing content is retransmitted. The process then ends. Specifics of each of these steps are explored below in more detail.

### A. System Setup

FIG. 6B is an example flow diagram for the process of setting-up the content delivery system for content delivery, shown generally at 605. This process begins with the receiver being preloaded with authentication keys. Likewise, the receiver may be preloaded with a user decryption key, at 606. In some embodiments, the authentication keys and/or user decryption key are preloaded into the receiver during manufacturing. Thus, the user may obtain the receiver with the initial set of authentication keys and user decryption key already installed. In some other embodiments, the user may have access to the authentication keys and/or user decryption key. Thus, when the user gets a new receiver unit, the authentication keys and/or user decryption key may be installed into the receiver post retail.

The user decryption key may be a singular key, or a collection of user decryption keys. Authentication keys may be unique to the receiver and/or common to many receivers Likewise, in some embodiments, the user decryption keys may be unique to either of the user or the receiver.

Then, often dependent upon changes to the content schedule, it may be desirous to update the keys within the receiver in order to successfully receive the transmitted content. Thus, in some embodiments, new content decryption key(s) may be encrypted using a user encryption key which corresponds to the user decryption key loaded in the receiver, at 607. Likewise, an authentication key identifier corresponding to at least one of the authentication keys loaded within the receiver may be embedded with the encrypted content decryption key, at 608. This identified and encrypted decryption key update may then be transmitted, at 609, for consumption by the proper receiver(s). Although not illustrated, updates to the authentication keys may likewise be transmitted to the receiver, in some embodiments. The process then ends by returning to step 610 of FIG. 6A.

### B. Content Transmission

FIG. 6C is an example flow diagram for the process of content transmission, shown generally at 610. This example process begins from step 605 of FIG. 6A. After which a content request is received from the user, at 611. This content request may take the form of a content schedule, as has been discussed above. Briefly refer to FIG. 6D where the process 611 is expanded. The content request, in some embodiments, includes receiving content identification (at 625), receiving delivery time requirements (at 626), receiving bandwidth availability (at 627), and generating a broadcast schedule (at 628). The broadcast schedule may compare bandwidth limitations to delivery time requirements to content size to generate an optimized delivery schedule. In some embodiments, the broadcast schedule includes buffers for retransmission of corrupted packets and for unplanned system slowdowns or other events.

The content schedule may be utilized to identify and collect the content from any of the above mentioned data sources. Data collected may be from a local database, or external databases. Additionally, internet and network queries may be utilized to collect the content.

Returning to FIG. 6C at 612, the content may then be packetized into discrete content packets (also referred to as data packets or datagrams). Packetization enables transmission of relatively large content data without the risk that an error in transmission will endanger the entire data transfer.

An inquiry is made at step 616 whether encryption of the data packets is desired. If so, the process progresses to step 613 where each of the packets may be encrypted utilizing the content encryption key(s). This step may be optional dependent upon security needs for the content. Thus, content where security is not at issue may skip the encryption step entirely. If, however, encryption is desirable, the choice of which content encryption key to use to encrypt the content packets may depend upon the intended recipient receivers' content decryption keys. For example, some receiver may include a personal device content decryption key as well as a universal emergency content decryption key and any number of subscription content decryption keys. A subscription content decryption key may be common among all subscribers who have a subscription. Thus, returning to a previous example, all users who have access to New York Times® may have a common content decryption key in their respective receivers which is associated with this subscription, and a transmission of the New York Times® may be encrypted with the corresponding content encryption key. All receivers with the content decryption key may then decode the transmission. Thus, a single encrypted New York Times® transmission is required to reach a number of targeted receivers and users.

After encryption, or if encryption was not desired, the process may continue to step 614 where an authentication key identifier may be embedded with each packet to help facilitate efficient delivery and routing. The authentication key identifier may remain unencrypted, thereby allowing all receivers to readily read the authentication key identifiers associated with each packet. If the authentication key identifier corresponds to a authentication key within the receiver, the receiver may then actively authenticate the packet. Likewise, the packet may also be decrypted when applicable. This efficiency is required due to the enormous volume of packets a typical receiver may be presented with. At very large packet numbers, a brute force attempt at authenticating and/or decrypting every packet to find the ones intended for the particular receiver becomes impractical. Thus, authentication key identifiers provide a method of selectively picking the packets for authentication by the receivers.

At 615, the packets are then transmitted to the receiver. The process then ends by returning to step 630 of FIG. 6A.

Briefly refer to FIG. 6E where the process 615 is expanded. Here a FM SCA subcarrier for the content packets is generated, at 629. The Subsidiary Communications Authority (SCA) is a subcarrier on a broadcasting station. The subcarrier is a modulated signal transmitted with the baseband signal. Typical subcarrier frequencies are 67 kHz and 92 kHz. The subcarrier at 67 kHz is typically received with more clarity and less interference. Additionally, sometimes data transmissions may occur at 71 kHz. Additional frequencies may be utilized as well. The transmitter from which to broadcast from is then selected, at 630. Lastly, at 631, the generated subcarrier signal is provided to the appropriate transmitter(s).

Now refer to FIG. 6F where step 630 is expanded. The method obtains receiver locations from the user profile (at step 636). Receiver locations may include set longitude and latitude coordinates for fixed receivers, or GPS coordinates (at step 637) for receivers which are mobile (such as receiver in cell phones or other mobile devices). Receiver location may then be cross referenced with the transmitter coverage area (at step 638) to determine which transmitters are best suited to transmit particular data packets.

After the last process of content transmission to the receivers is performed, the system may await a response from the receivers over a backchannel for error correction purposes.

### C. Error Correction

Processes 640 and 650 of FIG. 6A disclose the method of error correction for the present system. At 640, an inquiry is made whether a backchannel message has been received, and if so, whether the backchannel message indicates that there has been a transmission failure. Transmission failure may include failure of packet receipt, packet corruption, packet loss, and unsuccessful decryption of packets. If any of these failures are detected, the system may initiate a repair by retransmitting the damaged packets, at 650. This repair may include retransmission along the original transmission medium, and/or transmission of the repair data via the backchannel. In some embodiments, it is unnecessary to retransmit all of the content since the receivers are capable of storing all properly received packets and reconstituting the entire file once the newly retransmitted packets are received. Further, given the versatility of the present invention, any known methods for data recovery and repair of packets may be utilized by the present invention.

Briefly refer to FIG. 6G where the process 640 is expanded. Here a status message from the receiver is received by the delivery system, at 641. In some embodiments, the receivers provide periodic status updates where the content received is provided to the delivery system. In alternate embodiments, the receiver is capable of determining when a delivery error has occurred. In these embodiments, the receiver does not need to periodically send status messages, but rather needs to send a notification to the delivery system when an error has occurred.

At 642 the content received (as indicated by the status message) may be compared against the content transmitted to determine if and where a transmission error has occurred. In the embodiments where the receiver is capable of identifying and reporting errors, the error notification is sufficient to inform the system of a transmission error.

At 643, the inquiry is made whether there is an error using the analysis of 642. If no error is found, the process ends. If an error is found, the process progresses to step 650 of FIG. 6A where the missing or corrupted packets are retransmitted.

### D. Content Receipt

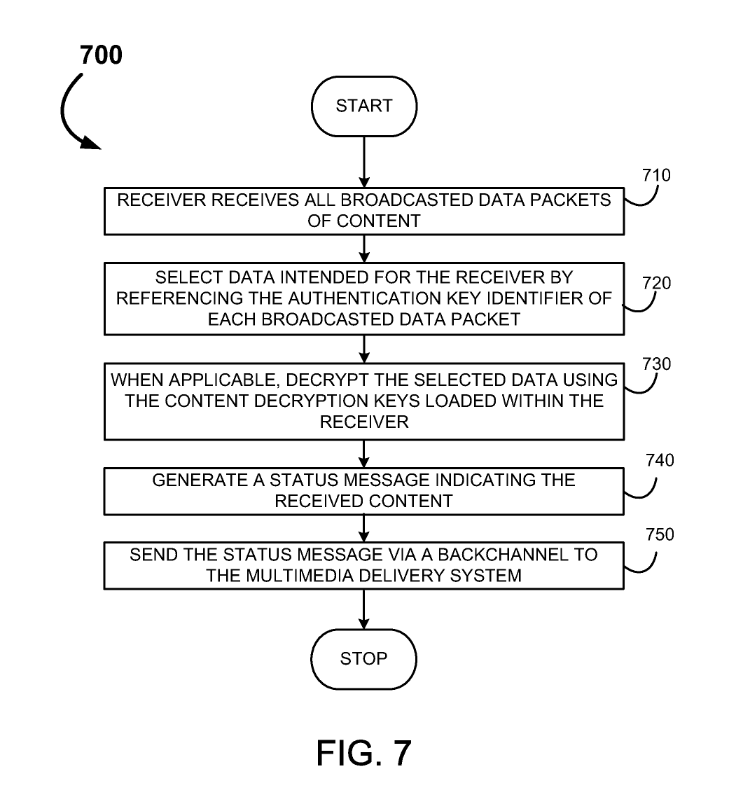

FIG. 7 is an example flow diagram for the process of receiving the transmitted content, using a receiver device, shown generally at 700. This process begins with the receiver receiving all broadcasted data packets, at 710. The receiver may then parse through the packets and select the data packets which are intended for it, at 720. This selection (authentication) may be performed by reviewing each of the authentication key identifiers embedded with the data packets.

An inquiry may be made as to whether the data packets are encrypted. If so, these selected data packets may then be decrypted using the content decryption keys in the receiver when the content is encrypted, at 730.

The receiver may then recreate the content from the individual data packets. Any errors in the content (due to missing or corrupted packets) may then be reported back to the delivery system. This may include generating a status message, at 740, indicating the content received (or the missing content). Then sending the status message to the multimedia delivery system, at 750, via a backchannel. The process then ends.

Backchannels may include cellular network transmission, modem transmission or wired transmission. Due to the relatively low bandwidth required by the backchannel, relatively “slow” transmission mediums may be acceptable. Use of a different backchannel medium from the original transmission medium also increases the likelihood that feedback reaches the system because a failure in the primary medium would not prevent feedback from being received by the system.

### E. User Profile Generation

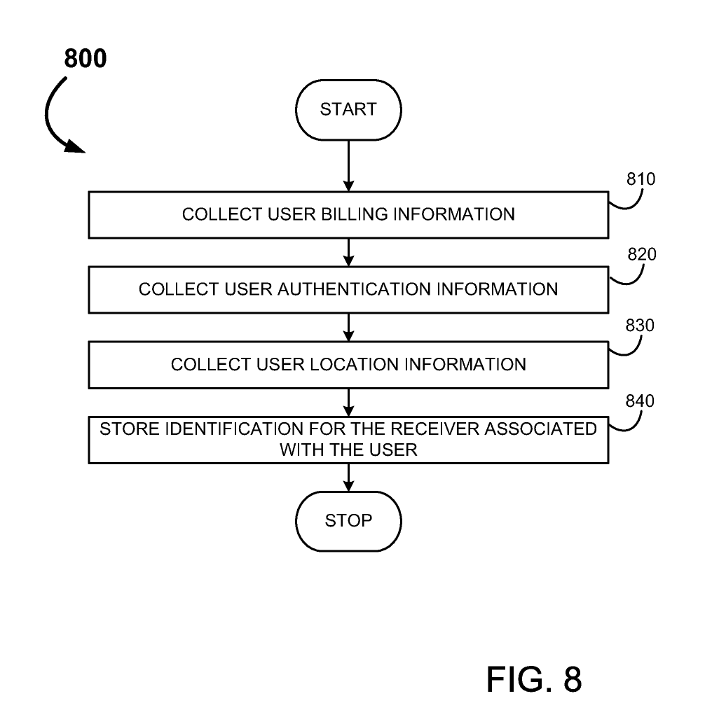

FIG. 8 is an example flow diagram for the process of generating the user profile, shown generally at 800. This process begins where user billing information may be collected (at step 810), authentication information is collected (at step 820), and user location is collected (at step 830). User location may include location coordinates for each receiver associated with the user. Location coordinates may include fixed coordinates and/or GPS coordinates. User authentication information may include a username and password, or any other known authentication methodology. Lastly, the identification of receivers associated with the user are stored (at step 840) as part of the user profile.

The identification of the receivers associated with the user may include information such as a serial number, authentication keys and user decryption keys actively stored within the receivers, receiver locations, receiver type and other useful information.

The user profile may also include user selections and preferences. One such preference is the type of content desired by the user. Content selection may be received via a web-based application, web-service or mobile applications, accessible by the registered user. Likewise, delivery time of content may be selected by the user.

### F. Transmission Penetration

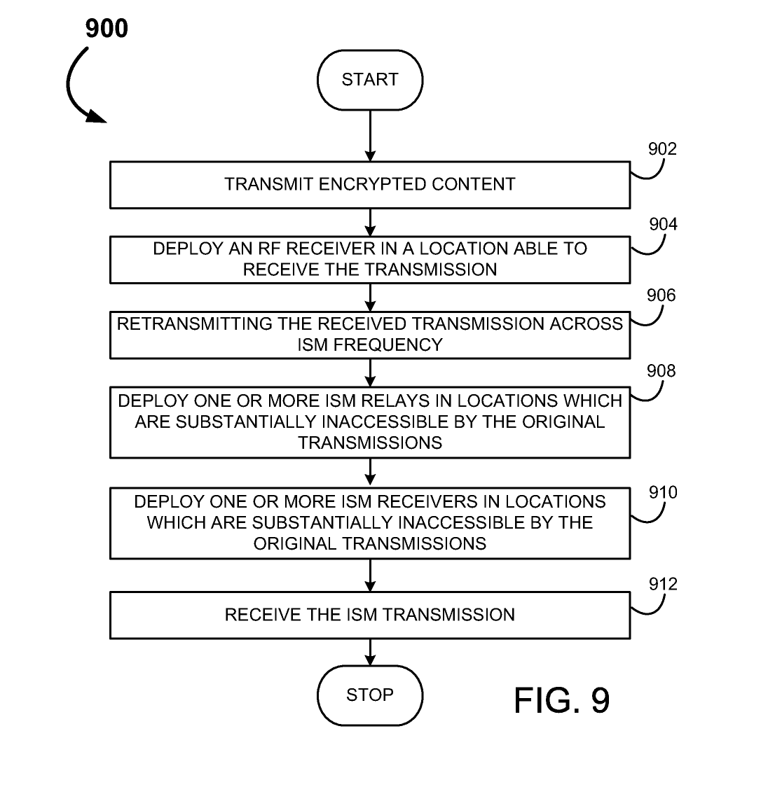

FIG. 9 is an example flow diagram for the process of relaying broadcast data to an inaccessible endpoint location, using a receiver and ISM relays, in accordance with an embodiment of the present invention, shown generally at 900. This process begins, again, with the transmission of the encoded data packets, at step 902. A receiver is deployed at a location capable of receiving the transmission, at step 904. In some embodiments, this process may be useful in scenarios where transmission penetration is difficult. For example, in a large office building FM radio bands do not typically penetrate the interior of the building very well. Thus, a receiver in the inside of an office building may require relays in order to function.

The process then proceeds to step 906, where the receiver retransmits the data packets over Industrial, Scientific and Medical (ISM) band (or other unlicensed bands suitable for localized low power transmissions). The benefit of using an ISM or other unlicensed band transmission is that there are fewer regulations placed upon this range of the radio frequency spectrum. Of course, additional retransmission bands may be utilized in alternate embodiments. In fact, in some embodiments, the receiver may be configured to couple to a wired corporate or building-wide network, thereby enabling endpoint receivers to directly couple to the network to receive the encoded data packets.

At step 908, one or more relays for the ISM transmission may be deployed within the building in regions where the original transmission is incapable of penetrating. ISM relays may be configured to receive the ISM transmission and retransmit the signal. Thus, relays may provide range extension for the original ISM transmitter. Further, at step 910, one or more ISM receivers may be deployed. The ISM receiver may be similar to the relays; however, the receivers may lack the ability to retransmit the ISM signal. These receivers may receive the ISM transmission at 912. The receivers with corresponding content authentication keys and optional decryption keys may then authenticate the appropriate data packets. In this way, the transmitted data may be received and decoded in an area where traditionally the RF transmission would not have been able to penetrate. The process then ends.

### III. EXAMPLES

### A. Radio Frequency SCA Subcarrier

As previously noted, data transmission may be performed, in some embodiments, utilizing one or more subcarrier signals. Again, for the purposes of this application, the term ‘subcarrier’ is defined as a separate signal carried on a main radio (or television) transmission, which carries additional data. The subcarrier is an already modulated signal, which is then modulated into yet another signal. A subcarrier may refer to Subsidiary Communications Authority (SCA) transmissions.

In the United States, the analog broadcast FM-band is the frequency region between 87.9 MHZ and 107.9 MHZ, inclusive. The region is subdivided into a plurality of one-hundred and one (101) channels (known as channels 200 to 300, inclusive) with a 200 kHz frequency spacing between adjacent channels. A radio station emits a RF signal, which is modulated with analog frequency modulation (FM) with certain limitations on the permitted frequency deviation, and which is nominally centered (i.e., without modulation) about the allocation frequency (e.g., 90.9 MHZ which is channel 210). The RF signal emissions are required to comply with an emissions “mask”. The mask is a power spectrum density envelope. The maximum emitted power varies as a function of the frequency offset from the nominal allocation center frequency. In other words, the emission mask determines the maximum power which may be emitted at a specific frequency (emission), for each frequency within the channel allocation. The signal emitted by the analog FM-band transmitter typically does not substantially exceed the mask frequency-envelope. The mask characteristics are determined by the FCC in the United States.

The Subsidiary Communications Authority (SCA) is a subcarrier on a broadcasting station. The subcarrier is a modulated signal transmitted with the baseband signal. As noted above, each FM channel is separated by 200 kHz. It is possible for a radio station to transmit audio up to 100 kHz (under current FM SCA rules). As the range of human hearing is generally restricted to 15 kHz there is substantial spectrum available for other uses. Typical subcarrier frequencies are 67 kHz and 92 kHz; however these frequencies are reserved for analog signals. The subcarrier at 67 kHz is typically received with more clarity and less interference. Additionally, sometimes data transmissions may occur at 71 kHz. Additional frequencies may be utilized as well.

### B. Datagram Protocols

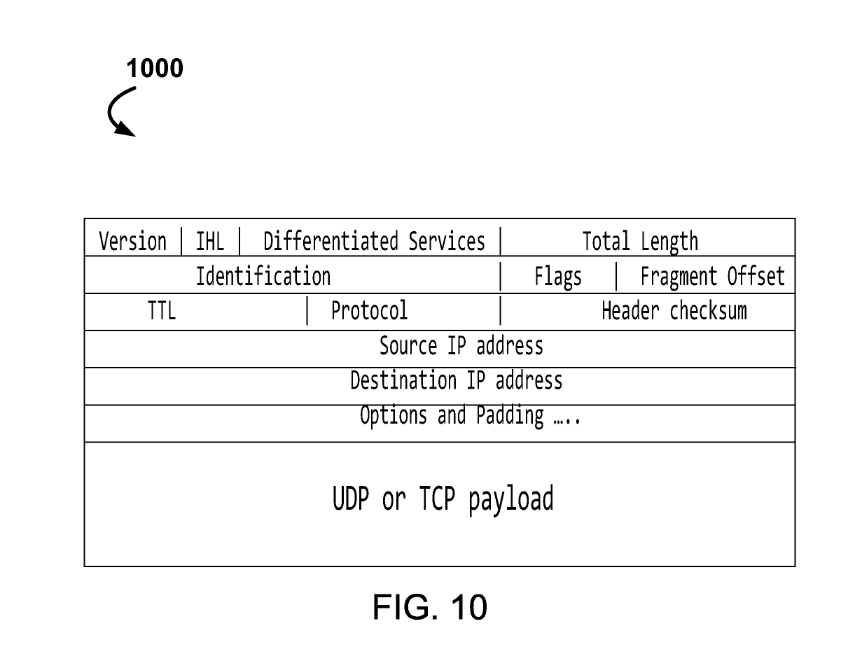

Below in reference to FIGS. 10 to 13 is provided examples of datagram protocol formats. Alternate protocols are also possible, in some embodiments.

FIG. 10 is the known Internet Protocol (IP) format for datagrams, shown generally at 1000. In an IP datagram, there are fields for logical IP addresses of the datagram source endpoint and the datagram destination endpoint. The IP addresses may have a correspondence to physical device media access control (MAC) address. The IP address uniquely identifies the destination endpoint among all possible IP endpoints. An IP datagram is inherently a unicast transfer.

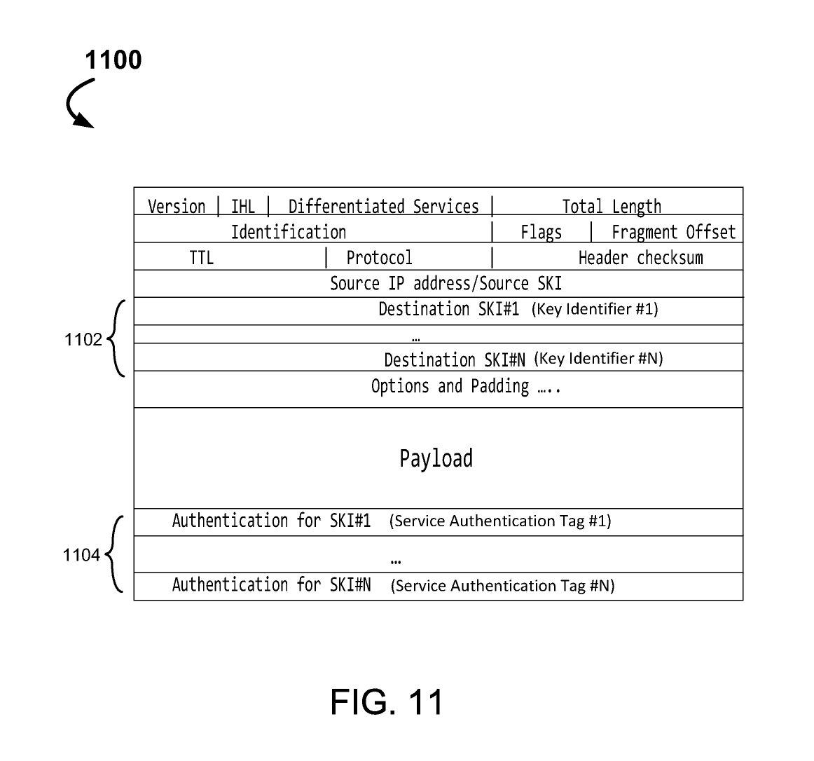

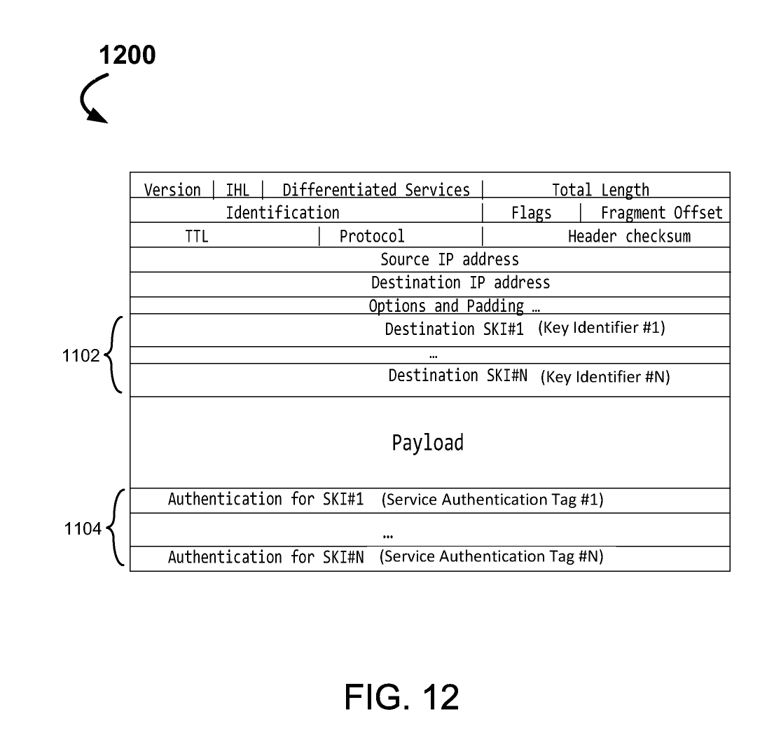

In contrast, a multicast datagram format shown in FIG. 11 is invented which replaces the logical endpoint address with one or a plurality of Service (authentication) Key Identifier (SKI) fields (1102). In some embodiments, a SKI header field (SKIH) is included in the datagram, preferably in the variable length Options field, in order to establish the number of SKI fields present in the datagram and format information for each SKI that is present. The SKI field represents an underlying authentication and/or service encryption key (SEK) which is used to cryptographically validate datagram traffic. There may be a one-to-one corresponding between the SKI and the SEK, so that routers and endpoints may identify the appropriate (secret) SEK on the basis of the revealed SKI. In some embodiments of the invention, shown in FIG. 12, it may be desirable to retain the IP destination IP address field for maximum compatibility even though the destination IP address will not, in general, correspond to the actual endpoint address. In these embodiments, the SKI fields may be generated in the variable length Options field. For example, the destination IP address may be used to route the multicast datagram traffic en masse as part of the network infrastructure for data distribution.

The SKI fields as an aggregate define a set association among endpoints for efficient data delivery. A SKI may represent a single physical endpoint device, all possible endpoints devices, or any possible grouping of endpoint devices. Thus, according to the invention, the SKI defines set membership in a plurality of possible set organizations. By incorporating multiple set identifiers in the datagram, the method and system of the invention significantly reduces the number of redundant datagram transfers to individual set members for shared content.

According to some embodiments of the invention, the datagram is authenticated by incorporating a service authentication field (Service Authentication Tag) in the data message. For each SKI in the datagram, there is a corresponding Service Authentication Tag field (1104). Endpoints which possess the correct SEK information can determine if the datagram is valid by computing the corresponding authentication field and comparing it to the field in the datagram. The authentication is computed over the header and including the datagram data payload. If the computed authentication field is identical to the authentication field in the datagram, then the endpoint may be assured that the datagram is valid. Thus, the SKI identifies the underlying authentication key which is used to determine datagram validity. A ‘spoofing’ datagram which may have a correct SKI field will not, in general, have the appropriate authentication field because the authentication is a unique function of the datagram content and the hidden key.

In certain embodiments where the privacy (versus the validity) of the datagram is not a concern, when, for example, the datagram payload includes information in the public domain, then only datagram authentication may be needed. However, when datagram secrecy is important, the datagram may be encrypted with one or a plurality of cryptographic codes. The content decryption key required to properly decrypt the datagrams is also identified by the SKI but the content decryption key is not necessary the same key as used for authentication. For example, the SKI may identify an underlying master key which is subjected to further one-way cryptographic transforms in order to determine separate authentication and content decryption keys. This approach is advantageous because the loss of security in one of the derived keys does not necessarily compromise the master key.

When the datagram contains one SKI field, encryption and authentication may be performed according to the derived keys. However, when more than one SKI field is present, the hierarchical relationship, if any, among the SKI fields should be taken into consideration, in some embodiments. If the SKI fields are not hierarchically related, it may be necessary to separately encrypt the datagram which different cryptographic codes. In this event, multiple datagrams with individual SKI fields may be required because duplication of the datagram body substantially eliminates the advantage of having multiple SKI's in a single datagram.

The system and method of the invention, in some embodiments, do not require specific bit field widths or specific methods of implementing authentication and encryption. However, in some embodiment, each SKI is a 128-bit field, and authentication may be accomplished by HMAC SHA-1 or SHA-2 algorithms, for example. Also, in some embodiments, authentication fields may be between 2 and 16 bytes, depending upon the level of security required. Payload encryption, when present, may be implemented using AES 128 or AES256 algorithms, in some embodiments.

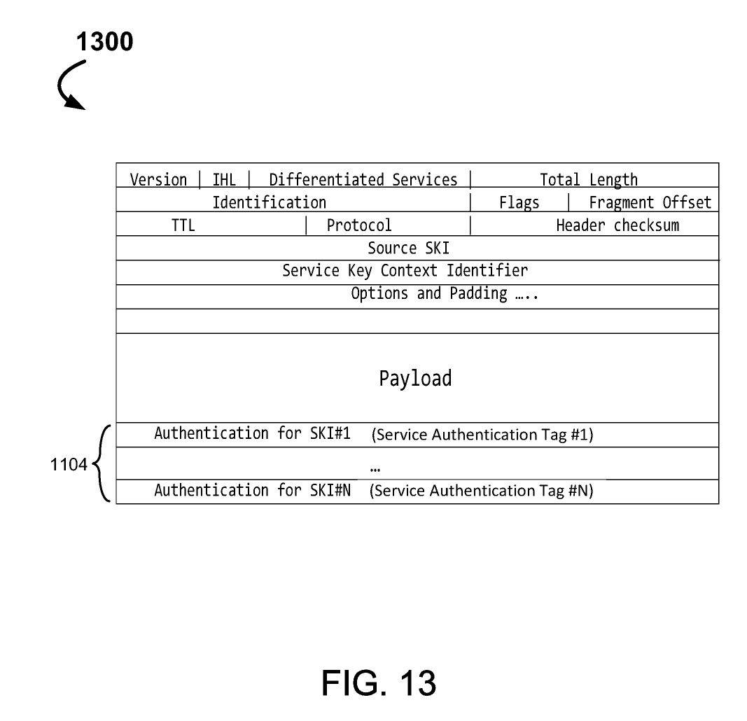

According to some embodiments of the invention, when a temporal sequence of datagram transfers is made with common SKI fields, the SKI information may be grouped together in a SKI context as shown in FIG. 13, shown generally at 1300. For individual datagrams within the sequence, an abbreviated service key context identifier (SKCI) may be used instead of the full SKI field information in order to reduce the required datagram size. Such datagrams sequences may be preceded by a datagram which identifies the correspondence between the SKI fields and the SKCI.

### C. Datagram Delivery

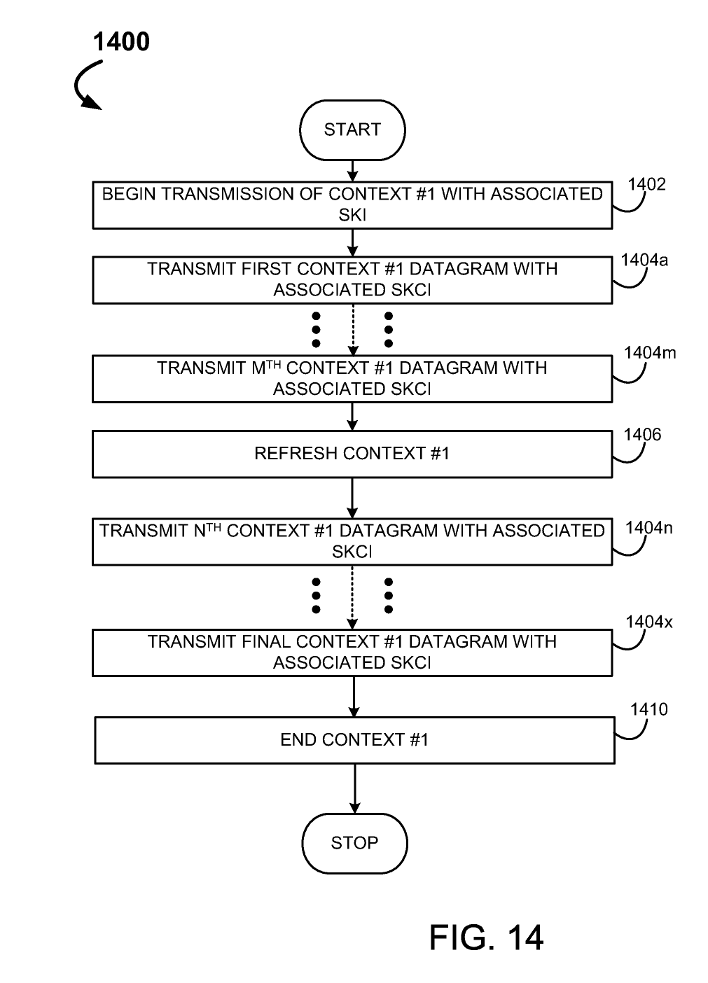

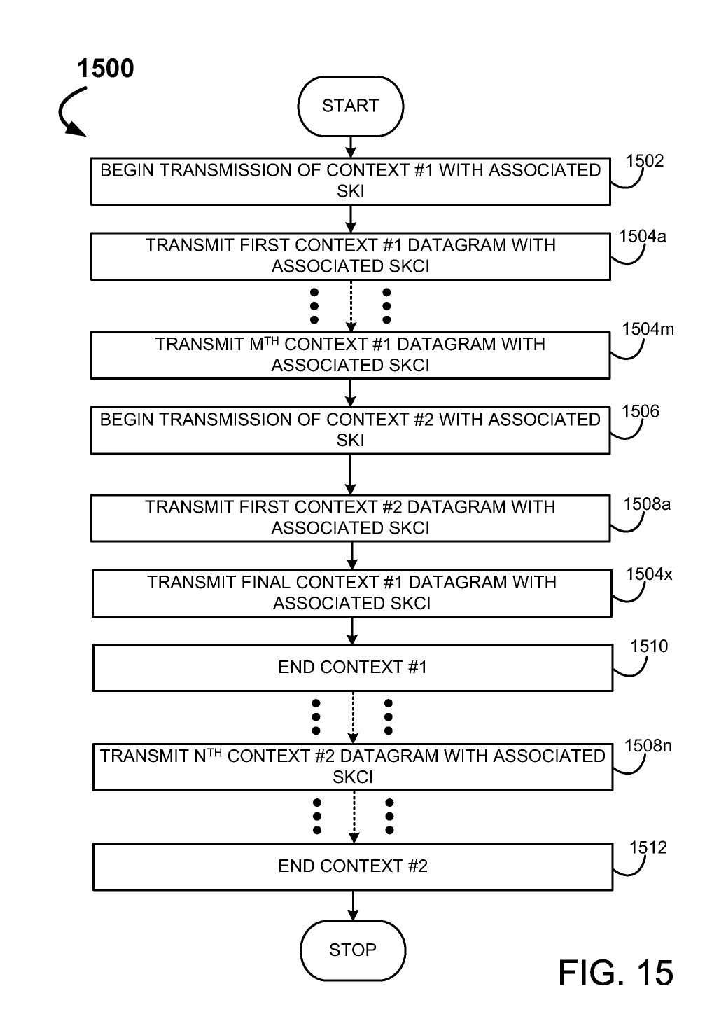

In some embodiment shown in FIG. 14, a start-of-context datagram is sent immediately prior to the sequence of datagrams with a common SKI context (at step 1402) and an end-of-context datagram is sent immediately subsequent to the transmission of the last datagram in the context (at step 1410). In order to facilitate alternating between contexts on a packet-by-packet basis, multiple contexts may be used. Thus, as shown in FIG. 15, it is possible to interleave packets from different contexts so long as i) the context identifiers are uniquely distinguishable and ii) the transfers within the context are properly framed by start-of-context and end-of-context datagrams. Datagrams transferred within the context are still required to be authenticated and/or encrypted according to the SKI. In many instances, it is desirable to include other large bit field information in the SKCI datagram which may be necessary to authenticate and/or decrypt the datagram, for example, cryptographic initialization vectors (IV).

According to some embodiments of the invention, when long sequences of datagrams with SKCI compression are transferred over a medium where packet losses occur without the possibility for repair (for example, one-way transmissions with no return channel), additional start-of-context datagrams may be sent at periodic intervals as shown at step 1406 of FIG. 14 to refresh the SKCI information, so that the loss of a single start-of-context datagram does not compromise the entire transfer. For example, when streaming digital audio using one-way digital radio technologies, a return path to confirm datagram reception may be too expensive or otherwise unavailable. In this case, the exact time at which the endpoint receiver is directed to receive packets for a given service may not be coincident with the arrival of a SKCI datagram. In this event, even if no further packet losses occur, datagram packets are not decodable until the arrival of the next SKCI datagram which identifies the appropriate context. For media applications, a repetition interval of less than about 4 seconds is recommended in order to accomplish acceptable acquisition delay. According to some embodiments of the invention, the endpoint receiver may cache SKCI datagram packets in its memory in order to quickly reconfigure for a service for which a SKCI datagram was previously received.

When a return path (backchannel) is available to determine reliable delivery of the datagrams (i.e., packet acknowledgement), the returned information is, in some embodiments, authenticated by the same key or a key common derived from the same master key as the received datagram that requires acknowledgement. This provides a guarantee of delivery without risk of datagram spoofing since the return acknowledgement packets require knowledge of the underlying authentication key for the transmitted datagram. The return path datagram may be a relatively low-level (for example, confirmation of the receipt of a specific datagram) or at an application level (for example, conformation of a playlist having successfully played out individual media items at specific times). According to some embodiments of the invention, the separation of the data communication paths into a separate ‘downlink’ and ‘uplink’ limits the system's vulnerability to the occurrence of datagram flooding, either intentionally initiated by malicious action or unintentionally in emergency situations (for example, civilian disasters), because i) the downlink throughput is unaffected by such attacks and ii) the uplink datagrams can be screened by fast authentication of the datagram sequences.

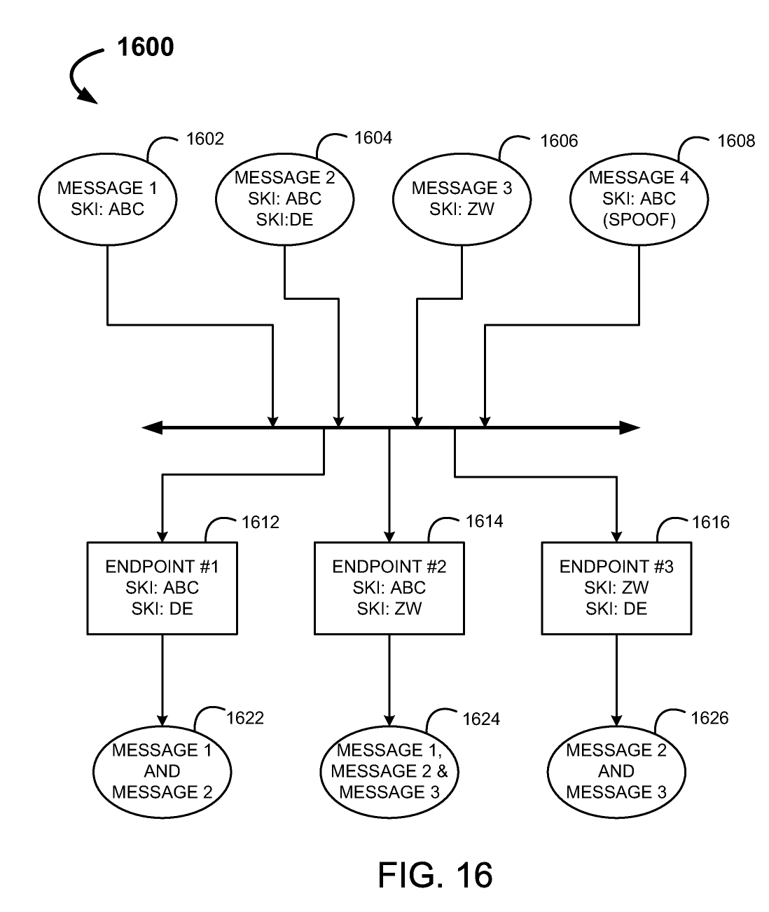

In some embodiments, in order to determine if datagrams are to be received by a specific endpoint (often a receiver, router or relay), each endpoint is required to maintain a table of (visible) service (authentication) key identifiers and their corresponding (secret) service encryption keys. As datagrams are received by the endpoint, the SKI entries in the datagram (or current context) are compared to the table entries. Authentication of the datagram payload is attempted if a match is found. Once a match is found, further examination of other SKI entries is not required. If none of the SKI fields in the datagram match the SKI fields in the internal endpoint table, the datagram is discarded. For example, in FIG. 16, four datagrams 1602, 1604, 1606 and 1608 are created for delivery to endpoints 1622, 1624 and 1626. The service keys are shortened and shown as alphabetic sequences for sake of clarity in the example. The visible keys are ABC, DE, and ZW. Three of the datagrams are valid (Msg1 1602, Msg2 1604 and Msg3 1606) and one datagram (Msg4 1608) is a ‘spoof’ datagram. The spoof datagram 1608 has the same SKI field (e.g., ABC, same as Msg1 and Msg2) but its authentication field does not correspond to the correct underlying key. For example, the spoof datagram 1608 may be introduced by a hacker in an attempt to send invalid data to an endpoint. The set grouping defines that Msg1 1602 is to be delivered to endpoints#1 and #2 1622 and 1624, respectively. Msg2 1604 is to be delivered to endpoints#2 and #3 1624 and 1626, respectively. Msg3 1606 is to be delivered to endpoints#2 and #3 1622 and 1624, respectively. Msg4 1608 is not received by any endpoint because none of the endpoints can successfully authenticate the spoofed packet even though the SKI is present in the endpoint table.

According to some embodiments of the invention, the SKI table entries in the endpoints may be perishable, in other words, the keys may have a specific time interval of validity, or the keys may be restricted in terms of use count. When the keys are validated by time, periodic time-of-day datagrams are sent to the endpoints in order to refresh current endpoint time unless the endpoint has a tamper-proof internal real-time clock (RTC). The timestamp datagrams, when sent, may, in general, be authenticated by the corresponding service (content) decryption keys. When a trusted source of timestamp datagrams is available, for example, from the network provider, it may be possible to use a ‘system-information’ key instead of a specific service decryption key, although timestamp authentication by actual service decryption keys (or derivable keys) is recommended in most applications to eliminate so-called “man-in-the-middle” risks. Thus, the timestamp identifies the time validity of the key. In some embodiments, the timestamp is signed by the appropriate key. If it is a timestamp on the encryption key, then the encryption key is used to sign the timestamp. On the other hand, if it is an authentication key, then the authentication key is used to sign the timestamp, in some embodiments of the invention.

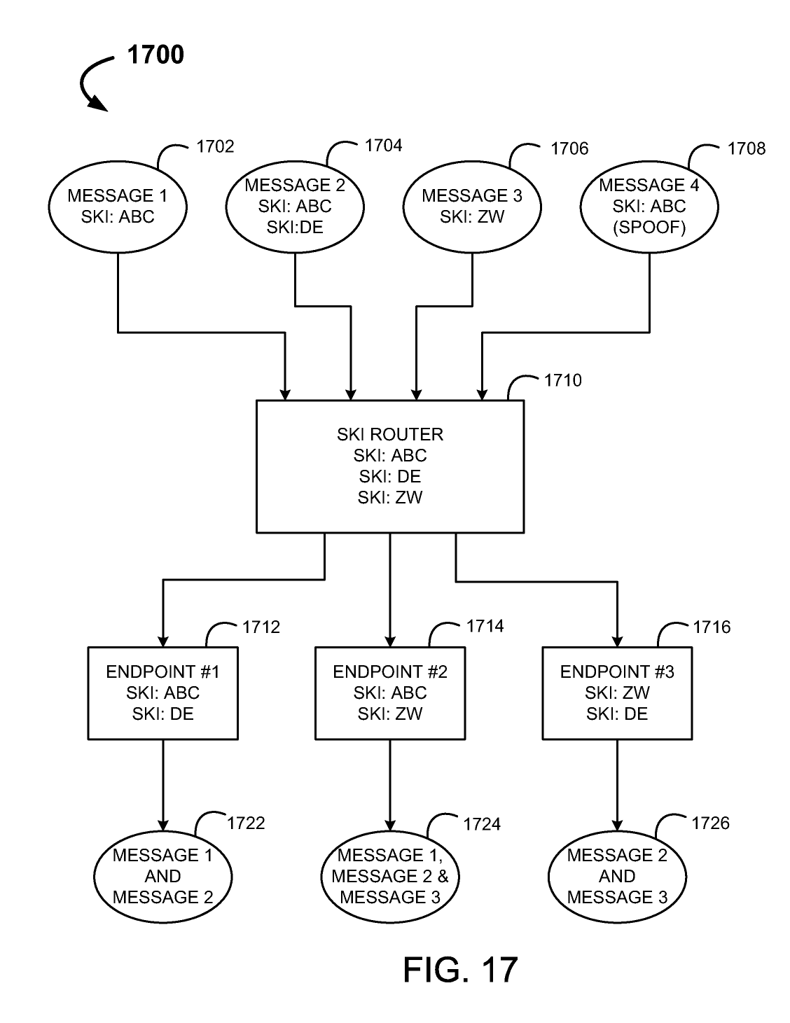

When the physical transport media is radio broadcast, as in some embodiments, there may be a direct physical connection (e.g., line-of-sight free space) between the source of the datagrams and the end points. In these implementations, further datagram routing is usually not required. However, when datagrams are needed to be transported across different physical media, it may be necessary to receive and re-transmit datagram traffic, for example, when converting from a short-range wireless physical link to a long-range optical fiber interconnection. In some embodiments it may be possible to re-transmit all of the datagram traffic, especially when transporting from a physical media with less bandwidth capacity to one with much greater capacity (for example, converting from FM SCA to short range wireless such as 900 MHz ISM-band). However, in many applications, it may be preferable to reduce the datagram traffic to those datagrams required for delivery to endpoints with a specific subset of authentication keys. According to the invention, in these embodiments, a service key router as shown in FIG. 17 may be implemented in order to determine the validity of datagrams prior to forwarding of the datagrams. The service key router 1710 is required to have service authentication key information for all authentication keys for endpoints 1712, 1714 and 1716 beyond the service key router 1710 boundary. An advantage of the service key router approach is that the router 1710 guarantees packet validity so that endpoints 1712, 1714 and 1716 beyond the router 1710 are not required to validate all of the datagrams, which may reduce the power and/or cost of endpoint implementation.

In sum, systems and methods for delivering content over a multicast broadcast medium are provided. While a number of specific examples have been provided to aid in the explanation of the present invention, it is intended that the given examples expand, rather than limit the scope of the invention. For example, in addition to the techniques described in the application for carrier spacing, frequency modulation and carrier types, it is considered within the scope of the invention to use alternate reasonable methods of data transmission, carrier channel generation and the like. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any of the methods disclosed is considered as disclosed by the present invention. Moreover, particular methodologies described in the detailed description are intended to be exemplary in nature. Known alternatives may be utilized as is desirable in any given circumstance. For example, while FM SCA has been described as the mode of datagram transmission, it may be possible to utilize additional methods of data transmission, such as In Band On Channel (IBOC) digital broadcasting in the AM and/or FM broadcast bands, and other known multiplexing methods Likewise, while authentication keys and decryption keys stored within the receiver have been described as independent and distinct keys, it may be possible in some embodiments of the invention that a single key is utilized for both authentication and decryption purposes.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A method for securely routing content by router, wherein the router is associated with a user, the method comprising:
receiving, by the router, at least one content transmission from a transmitter, wherein the at least one content transmission includes one or more authentication key identifiers, wherein at least one authentication key identifier is an authenticating key identifier configured to facilitate routing;
storing one or more authentication keys in the router, wherein at least one authentication key is an authentication key configured to facilitate routing;
authenticating, by the router, the at least one content transmission, wherein the authentication of the at least one content transmission includes matching the at least one authenticating key identifiers configured to facilitate routing embedded in each content transmission against the at least one authentication keys configured to facilitate routing; and
transmitting, by the router, authenticated content transmissions to a receiver.

2. The method of claim 1, wherein at least one of the authentication keys is a content authentication key, and wherein at least one of the authentication key identifiers is a content authentication key identifier.

3. The method of claim 1, wherein the authentication keys have a hierarchical relationship with respect to one another, and wherein the embedded authentication key identifiers have a hierarchical relationship with respect to one another.

4. The method of claim 2 comprising:
authenticating, by the router, at least one content transmission,
wherein the authentication of the at least one content transmission includes matching the at least one content authentication key identifiers embedded in each content transmission against the at least one content authentication keys.

5. The method of claim 4, wherein the at least one content transmission includes encrypted content, the encrypted content comprising at least one content encryption keys, wherein each content encryption key corresponds to at least one content decryption key stored in the router.

6. The method of claim 5 comprising decrypting, by the router, the encrypted content using the at least one content decryption key.

7. A system for securely routing content from a transmitter, the system comprising:
a router configured to:
receive at least one content transmission from the transmitter, wherein the at least one content transmission includes one or more authentication key identifiers, wherein at least one authentication key identifier is an authenticating key identifier configured to facilitate routing;
store one or more authentication keys in the router, wherein at least one authentication key is an authentication key configured to facilitate routing;
authenticate the at least one content transmission, wherein the authentication of the at least one content transmission includes matching the at least one authenticating key identifiers configured to facilitate routing embedded in each content transmission against the at least one authentication keys configured to facilitate routing; and
transmit authenticated content transmissions to a receiver.

8. The system of claim 7, wherein at least one of the authentication keys is a content authentication key, and wherein at least one of the authentication key identifiers is a content authentication key identifier.

9. The system of claim 7, wherein the authentication keys have a hierarchical relationship with respect to one another, and wherein the embedded authentication key identifiers have a hierarchical relationship with respect to one another.

10. The system of claim 8, wherein the router is configured to authenticate at least one content transmission, wherein the authentication of the at least one content transmission includes matching the at least one content authentication key identifiers embedded in each content transmission against the at least one content authentication keys.

11. The system of claim 10, wherein the at least one content transmission includes encrypted content, the encrypted content comprising at least one content encryption keys, wherein each content encryption key corresponds to at least one content decryption key stored in the router.

12. The system of claim 11, wherein the router is configured to decrypt the encrypted content using the at least one content decryption key.
